(19) United States
(12) Patent Application Publication
(10) Pub. No.: US 2025/0047396 A1
(43) Pub. Date: Feb. 6, 2025

(54) CROSS-LINK INTERFERENCE REPORT WITH MULTIPLE HYPOTHESES

(71) Applicant: QUALCOMM Incorporated, San Diego, CA (US)

(72) Inventors: Qian ZHANG, Basking Ridge, NJ (US); Yan ZHOU, San Diego, CA (US); Tao LUO, San Diego, CA (US)

(21) Appl. No.: 18/365,786

(22) Filed: Aug. 4, 2023

(51) Int. Cl. H04B 17/345; H04W 24/08

(52) U.S. Cl. CPC H04B 17/345; H04W 24/08

(57) ABSTRACT

Methods, systems, and devices for wireless communications are described. For instance, a first network entity may receive, from a second network entity, first control information that includes first information and second information, where the first information is indicative of one or more interference measurement resources for measurement of cross-link interference and the second information may be indicative of a set of hypotheses for one or more CLI determinations. The first network entity may transmit, to the second network entity, a report that includes respective CLI information for two or more of the plurality of hypotheses, where the respective CLI information for the two or more hypotheses is based on the first information indicative of the one or more interference measurement resources.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support cross-link interference report with multiple hypotheses. For example, the described techniques provide for a network entity to reduce cross-link interference (CLI) via reporting of multiple hypotheses. A first network entity may receive, from a second network entity, first control information that includes first information and second information, where the first information is indicative of one or more interference measurement resources for measurement of cross-link interference and the second information may be indicative of a set of hypotheses for one or more CLI determinations. The first network entity may transmit, to the second network entity, a report that includes respective CLI information for two or more of the plurality of hypotheses, where the respective CLI information for the two or more hypotheses is based on the first information indicative of the one or more interference measurement resources.

A method for wireless communication performed by a first network entity is described. The method may include receiving, from a second network entity, first control information that includes first information and second information, where the first information is indicative of one or more interference measurement resources for measurement of CLI and the second information is indicative of a set of multiple hypotheses for one or more CLI determinations and transmitting, to the second network entity, a report that includes respective CLI information for each hypothesis of two or more of the set of multiple hypotheses, where the respective CLI information for each hypothesis of the two or more hypotheses is based on the first information indicative of the one or more interference measurement resources.

A first network entity for wireless communication performed is described. The first network entity may include one or more memories storing processor executable code, and one or more processors coupled with the one or more memories. The one or more processors may individually or collectively operable to execute the code to cause the first network entity to receive, from a second network entity, first control information that includes first information and second information, where the first information is indicative of one or more interference measurement resources for measurement of CLI and the second information is indicative of a set of multiple hypotheses for one or more CLI determinations and transmit, to the second network entity, a report that includes respective CLI information for each hypothesis of two or more of the set of multiple hypotheses, where the respective CLI information for each hypothesis of the two or more hypotheses is based on the first information indicative of the one or more interference measurement resources.

Another first network entity for wireless communication performed is described. The first network entity may include means for receiving, from a second network entity, first control information that includes first information and second information, where the first information is indicative of one or more interference measurement resources for measurement of CLI and the second information is indicative of a set of multiple hypotheses for one or more CLI determinations and means for transmitting, to the second network entity, a report that includes respective CLI information for each hypothesis of two or more of the set of multiple hypotheses, where the respective CLI information for each hypothesis of the two or more hypotheses is based on the first information indicative of the one or more interference measurement resources.

A non-transitory computer-readable medium storing code for wireless communication performed is described. The code may include instructions executable by a processor to receive, from a second network entity, first control information that includes first information and second information, where the first information is indicative of one or more interference measurement resources for measurement of CLI and the second information is indicative of a set of multiple hypotheses for one or more CLI determinations and transmit, to the second network entity, a report that includes respective CLI information for each hypothesis of two or more of the set of multiple hypotheses, where the respective CLI information for each hypothesis of the two or more hypotheses is based on the first information indicative of the one or more interference measurement resources.

In some examples of the method, first network entities, and non-transitory computer-readable medium described herein, the two or more hypotheses include a first hypothesis and a second hypothesis, the respective CLI information for the first hypothesis includes a channel quality indicator (CQI), a rank indicator (RI), a precoding matrix indicator (PMI), or a signal to interference plus noise ratio (SINR), and the first hypothesis may be associated with an absence of CLI measurement and the second hypothesis that may be associated with CLI measurement based on the one or more interference measurement resources.

In some examples of the method, first network entities, and non-transitory computer-readable medium described herein, the two or more hypotheses include a first hypothesis associated with a first transmit power backoff value and a second hypothesis associated with a second transmit power backoff value and each of the first transmit power backoff value and the second transmit power backoff value may be equal to or greater than zero.

Some examples of the method, first network entities, and non-transitory computer-readable medium described herein may further include operations, features, means, or instructions for receiving, from the second network entity, second control information indicative of the first transmit power backoff value and the second transmit power backoff value.

In some examples of the method, first network entities, and non-transitory computer-readable medium described herein, at least one interference measurement resource of the one or more interference measurement resources may be associated with multiple hypotheses of the two or more hypotheses.

In some examples of the method, first network entities, and non-transitory computer-readable medium described herein, a first interference measurement resource of the one or more interference measurement resources may be associated with a first hypothesis of the two or more hypotheses and a second interference measurement resource of the one or more interference measurement resources may be associated with a second hypothesis of the two or more hypotheses.

In some examples of the method, first network entities, and non-transitory computer-readable medium described herein, a first hypothesis of the set of multiple hypotheses may be associated with a first interference measurement resource of the one or more interference measurement resources and a second interference measurement resource of the one or more interference measurement resources, a second hypothesis of the set of multiple hypotheses may be associated with only the first interference measurement resource, and a third hypothesis of the set of multiple hypotheses may be associated with only the second interference measurement resource.

In some examples of the method, first network entities, and non-transitory computer-readable medium described herein, a first hypothesis of the set of multiple hypotheses may be associated with a first interference measurement resource of the one or more interference measurement resources and a first power control backoff value, a second hypothesis of the set of multiple hypotheses may be associated with the first interference measurement resource and a second power control backoff value, a third hypothesis of the set of multiple hypotheses may be associated with a second interference measurement resource of the one or more interference measurement resources and the first power control backoff value, and a fourth hypothesis of the set of multiple hypotheses may be associated with the second interference measurement resource and the second power control backoff value.

In some examples of the method, first network entities, and non-transitory computer-readable medium described herein, a fifth hypothesis of the set of multiple hypotheses may be associated with the first power control backoff value for the first interference measurement resource and the first power control backoff value for the second interference measurement resource, a sixth hypothesis of the set of multiple hypotheses may be associated with the second power control backoff value for the first interference measurement resource and the second power control backoff value for the second interference measurement resource, a seventh hypothesis of the set of multiple hypotheses may be associated with the first power control backoff value for the first interference measurement resource and the second power control backoff value for the second interference measurement resource, and an eighth hypothesis of the set of multiple hypotheses may be associated with the second power control backoff value for the first interference measurement resource and the first power control backoff value for the second interference measurement resource.

In some examples of the method, first network entities, and non-transitory computer-readable medium described herein, the two or more hypotheses include a first hypothesis associated with a first transmit beam of a third network entity and a second hypothesis associated with a second transmit beam of the third network entity.

In some examples of the method, first network entities, and non-transitory computer-readable medium described herein, the two or more hypotheses include a first hypothesis associated with a CLI measurement associated with a first receive beam of the first network entity and a second hypothesis associated with a second receive beam of the first network entity.

In some examples of the method, first network entities, and non-transitory computer-readable medium described herein, the two or more hypotheses include a first hypothesis associated with a third network entity and a second hypothesis associated with a fourth network entity.

In some examples of the method, first network entities, and non-transitory computer-readable medium described herein, the two or more hypotheses may have a first quantity of hypotheses and the set of multiple hypotheses may have a second quantity of hypotheses and the first quantity of hypotheses may be less than the second quantity of hypotheses.

Some examples of the method, first network entities, and non-transitory computer-readable medium described herein may further include operations, features, means, or instructions for determining the two or more hypotheses based on a maximum quantity of hypotheses associated with the report.

In some examples of the method, first network entities, and non-transitory computer-readable medium described herein, determining the two or more hypotheses based on maximum quantity of hypotheses associated with the report may include operations, features, means, or instructions for selecting the two or more hypotheses.

Some examples of the method, first network entities, and non-transitory computer-readable medium described herein may further include operations, features, means, or instructions for generating, based on selecting the two or more hypotheses, the report to include the respective CLI information for each hypothesis of the two or more hypotheses.

In some examples of the method, first network entities, and non-transitory computer-readable medium described herein, the one or more interference measurement resources include a set of multiple interference measurement resources for each network entity of a set of multiple network entities, the two or more hypotheses include hypotheses associated with any of N interference measurement resources of the set of multiple interference measurement resources for each network entity of the set of multiple network entities, the N interference measurement resources may be associated with a higher interference than each remaining interference measurement resource of the set of multiple interference measurement resources for each network entity of the set of multiple network entities, and N may be a positive integer.

In some examples of the method, first network entities, and non-transitory computer-readable medium described herein, the one or more interference measurement resources include a set of multiple interference measurement resources for each network entity of a set of multiple network entities, the two or more hypotheses include hypotheses associated with any of N interference measurement resources of the set of multiple interference measurement resources for each network entity of the set of multiple network entities, the N interference measurement resources may be associated with a lower interference than each remaining interference measurement resource of the set of multiple interference measurement resources for each network entity of the set of multiple network entities, and N may be a positive integer.

In some examples of the method, first network entities, and non-transitory computer-readable medium described herein, the respective CLI information for each hypothesis of the two or more hypotheses includes a respective CQI, a respective RI, a respective PMI, a respective received signal strength indicator (RSSI), a respective reference signal receive power (RSRP), or a respective SINR.

In some examples of the method, first network entities, and non-transitory computer-readable medium described herein, the report includes channel state information.

In some examples of the method, first network entities, and non-transitory computer-readable medium described herein, the first control information may be indicated in a report configuration.

In some examples of the method, first network entities, and non-transitory computer-readable medium described herein, each CLI determination of the one or more CLI determinations may be associated with the respective CLI information or a respective measurement of CLI for a respective hypothesis of the two or more hypotheses.

Some examples of the method, first network entities, and non-transitory computer-readable medium described herein may further include operations, features, means, or instructions for generating, based on the one or more interference measurement resources, the respective CLI information for each hypothesis of the two or more hypotheses.

In some examples of the method, first network entities, and non-transitory computer-readable medium described herein, generating, based on the one or more interference measurement resources, the respective CLI information for each hypothesis of the one or more hypotheses may include operations, features, means, or instructions for measuring the one or more interference measurement resources.

A method for wireless communication performed by a first network entity is described. The method may include transmitting, to a second network entity, first control information that includes first information and second information, where the first information is indicative of one or more interference measurement resources for measurement of CLI and the second information is indicative of a set of multiple hypotheses for one or more CLI determinations and receiving, from the second network entity, a report that includes respective CLI information for each hypothesis of two or more of the set of multiple hypotheses, where the respective CLI information for each hypothesis of the two or more hypotheses is based on the first information indicative of the one or more interference measurement resources.

A first network entity for wireless communication performed is described. The first network entity may include one or more memories storing processor executable code, and one or more processors coupled with the one or more memories. The one or more processors may individually or collectively operable to execute the code to cause the first network entity to transmit, to a second network entity, first control information that includes first information and second information, where the first information is indicative of one or more interference measurement resources for measurement of CLI and the second information is indicative of a set of multiple hypotheses for one or more CLI determinations and receive, from the second network entity, a report that includes respective CLI information for each hypothesis of two or more of the set of multiple hypotheses, where the respective CLI information for each hypothesis of the two or more hypotheses is based on the first information indicative of the one or more interference measurement resources.

Another first network entity for wireless communication performed is described. The first network entity may include means for transmitting, to a second network entity, first control information that includes first information and second information, where the first information is indicative of one or more interference measurement resources for measurement of CLI and the second information is indicative of a set of multiple hypotheses for one or more CLI determinations and means for receiving, from the second network entity, a report that includes respective CLI information for each hypothesis of two or more of the set of multiple hypotheses, where the respective CLI information for each hypothesis of the two or more hypotheses is based on the first information indicative of the one or more interference measurement resources.

A non-transitory computer-readable medium storing code for wireless communication performed is described. The code may include instructions executable by a processor to transmit, to a second network entity, first control information that includes first information and second information, where the first information is indicative of one or more interference measurement resources for measurement of CLI and the second information is indicative of a set of multiple hypotheses for one or more CLI determinations and receive, from the second network entity, a report that includes respective CLI information for each hypothesis of two or more of the set of multiple hypotheses, where the respective CLI information for each hypothesis of the two or more hypotheses is based on the first information indicative of the one or more interference measurement resources.

In some examples of the method, first network entities, and non-transitory computer-readable medium described herein, the two or more hypotheses include a first hypothesis and a second hypothesis, the respective CLI information for the first hypothesis includes a CQI, a RI, a PMI, or a SINR, and the first hypothesis may be associated with an absence of CLI measurement and the second hypothesis that may be associated with CLI measurement based on the one or more interference measurement resources.

In some examples of the method, first network entities, and non-transitory computer-readable medium described herein, the two or more hypotheses include a first hypothesis associated with a first transmit power backoff value and a second hypothesis associated with a second transmit power backoff value and each of the first transmit power backoff value and the second transmit power backoff value may be equal to or greater than zero.

Some examples of the method, first network entities, and non-transitory computer-readable medium described herein may further include operations, features, means, or instructions for transmitting, to the second network entity or a third network entity, second control information indicative of the first transmit power backoff value and the second transmit power backoff value.

In some examples of the method, first network entities, and non-transitory computer-readable medium described herein, at least one interference measurement resource of the one or more interference measurement resources may be associated with multiple hypotheses of the two or more hypotheses.

In some examples of the method, first network entities, and non-transitory computer-readable medium described herein, a first interference measurement resource of the one or more interference measurement resources may be associated with a first hypothesis of the two or more hypotheses and a second interference measurement resource of the one or more interference measurement resources may be associated with a second hypothesis of the two or more hypotheses.

In some examples of the method, first network entities, and non-transitory computer-readable medium described herein, a first hypothesis of the set of multiple hypotheses may be associated with a first interference measurement resource of the one or more interference measurement resources and a second interference measurement resource of the one or more interference measurement resources, a second hypothesis of the set of multiple hypotheses may be associated with only the first interference measurement resource, and a third hypothesis of the set of multiple hypotheses may be associated with only the second interference measurement resource.

In some examples of the method, first network entities, and non-transitory computer-readable medium described herein, a first hypothesis of the set of multiple hypotheses may be associated with a first interference measurement resource of the one or more interference measurement resources and a first power control backoff value, a second hypothesis of the set of multiple hypotheses may be associated with the first interference measurement resource and a second power control backoff value, a third hypothesis of the set of multiple hypotheses may be associated with a second interference measurement resource of the one or more interference measurement resources and the first power control backoff value, and a fourth hypothesis of the set of multiple hypotheses may be associated with the second interference measurement resource and the second power control backoff value.

In some examples of the method, first network entities, and non-transitory computer-readable medium described herein, a fifth hypothesis of the set of multiple hypotheses may be associated with the first power control backoff value for the first interference measurement resource and the first power control backoff value for the second interference measurement resource, a sixth hypothesis of the set of multiple hypotheses may be associated with the second power control backoff value for the first interference measurement resource and the second power control backoff value for the second interference measurement resource, a seventh hypothesis of the set of multiple hypotheses may be associated with the first power control backoff value for the first interference measurement resource and the second power control backoff value for the second interference measurement resource, and an eighth hypothesis of the set of multiple hypotheses may be associated with the second power control backoff value for the first interference measurement resource and the first power control backoff value for the second interference measurement resource.

In some examples of the method, first network entities, and non-transitory computer-readable medium described herein, the two or more hypotheses include a first hypothesis associated with a first transmit beam of a third network entity and a second hypothesis associated with a second transmit beam of the third network entity.

In some examples of the method, first network entities, and non-transitory computer-readable medium described herein, the two or more hypotheses include a first hypothesis associated with a first receive beam of the second network entity and a second hypothesis associated with a second receive beam of the second network entity.

In some examples of the method, first network entities, and non-transitory computer-readable medium described herein, the two or more hypotheses include a first hypothesis associated with a third network entity and a second hypothesis associated with a fourth network entity.

In some examples of the method, first network entities, and non-transitory computer-readable medium described herein, the two or more hypotheses may have a first quantity of hypotheses and the set of multiple hypotheses may have a second quantity of hypotheses and the first quantity of hypotheses may be less than the second quantity of hypotheses.

In some examples of the method, first network entities, and non-transitory computer-readable medium described herein, the two or more hypotheses may be based on a maximum quantity of hypotheses associated with the report.

In some examples of the method, first network entities, and non-transitory computer-readable medium described herein, the one or more interference measurement resources include a set of multiple interference measurement resources for each network entity of a set of multiple network entities, the two or more hypotheses include hypotheses associated with any of N interference measurement resources of the set of multiple interference measurement resources for each network entity of the set of multiple network entities, the N interference measurement resources may be associated with a higher interference than each remaining interference measurement resource of the set of multiple interference measurement resources for each network entity of the set of multiple network entities, and N may be a positive integer.

In some examples of the method, first network entities, and non-transitory computer-readable medium described herein, the one or more interference measurement resources include a set of multiple interference measurement resources for each network entity of a set of multiple network entities, the two or more hypotheses include hypotheses associated with any of N interference measurement resources of the set of multiple interference measurement resources for each network entity of the set of multiple network entities, the N interference measurement resources may be associated with a lower interference than each remaining interference measurement resource of the set of multiple interference measurement resources for each network entity of the set of multiple network entities, and N may be a positive integer.

In some examples of the method, first network entities, and non-transitory computer-readable medium described herein, the respective CLI information for each hypothesis of the two or more hypotheses includes a respective CQI, a respective RI, a respective PMI, a respective RSSI, a respective RSRP, or a respective SINR.

In some examples of the method, first network entities, and non-transitory computer-readable medium described herein, the first control information may be indicated in a report configuration.

In some examples of the method, first network entities, and non-transitory computer-readable medium described herein, each CLI determination of the one or more CLI determinations may be associated with the respective CLI information or a respective measurement of CLI for a respective hypothesis of the two or more hypotheses.

### BRIEF DESCRIPTION OF THE DRAWINGS

FIG. 1 shows an example of a wireless communications system that supports cross-link interference report with multiple hypotheses in accordance with one or more aspects of the present disclosure.

FIG. 2 shows an example of a wireless communications system that supports cross-link interference report with multiple hypotheses in accordance with one or more aspects of the present disclosure.

FIG. 3 shows an example of a wireless communications system that supports cross-link interference report with multiple hypotheses in accordance with one or more aspects of the present disclosure.

FIG. 4 shows an example of a wireless communications system that supports cross-link interference report with multiple hypotheses in accordance with one or more aspects of the present disclosure.

FIG. 5 shows an example of a wireless communications system that supports cross-link interference report with multiple hypotheses in accordance with one or more aspects of the present disclosure.

FIG. 6 shows an example of a wireless communications system that supports cross-link interference report with multiple hypotheses in accordance with one or more aspects of the present disclosure.

FIG. 7 shows an example of a wireless communications system that supports cross-link interference report with multiple hypotheses in accordance with one or more aspects of the present disclosure.

FIG. 8 shows an example of a wireless communications system that supports cross-link interference report with multiple hypotheses in accordance with one or more aspects of the present disclosure.

FIG. 9 shows an example of a process flow that supports cross-link interference report with multiple hypotheses in accordance with one or more aspects of the present disclosure.

FIGS. 10 and 11 show block diagrams of devices that support cross-link interference report with multiple hypotheses in accordance with one or more aspects of the present disclosure.

FIG. 12 shows a block diagram of a communications manager that supports cross-link interference report with multiple hypotheses in accordance with one or more aspects of the present disclosure.

FIG. 13 shows a diagram of a system including a device that supports cross-link interference report with multiple hypotheses in accordance with one or more aspects of the present disclosure.

FIGS. 14 and 15 show block diagrams of devices that support cross-link interference report with multiple hypotheses in accordance with one or more aspects of the present disclosure.

FIG. 16 shows a block diagram of a communications manager that supports cross-link interference report with multiple hypotheses in accordance with one or more aspects of the present disclosure.

FIG. 17 shows a diagram of a system including a device that supports cross-link interference report with multiple hypotheses in accordance with one or more aspects of the present disclosure.

FIGS. 18 and 19 show flowcharts illustrating methods that support cross-link interference report with multiple hypotheses in accordance with one or more aspects of the present disclosure.

### DETAILED DESCRIPTION

A first network entity (e.g., a user equipment (UE)) receiving a message from a second network entity (e.g., a base station) may experience cross-link interference (CLI) from another transmission, where the other transmission may originate from a third network entity (e.g., a UE) or from the first network interference. If the other transmission originates from the first network entity, it may be referred to as self-interference. In some examples, the network entity that acts as a source of interference may be referred to as an aggressor network entity and the network entity that is affected by the interference may be referred to as a victim network entity. As a power of CLI increases over a set of resources over which the message is received, the first UE may have a decreased likelihood of successfully decoding the first message. Techniques that decrease CLI or maintain CLI below a threshold value may enable the first network entity to be more likely to successfully decode the first message and, thus, may increase the efficiency of wireless communications.

The present disclosure describes techniques that enable CLI to be decreased or maintained below the threshold value. For instance, the network entity may generate a CLI report that includes CLI information for multiple hypotheses, where each hypothesis corresponds to a respective condition under which values of parameters associated with CLI are determined. For instance, the values of these parameters may be determined assuming different backoff transmit powers for an aggressor network entity and/or by measuring different transmit beams of an aggressor network entity, transmit beams of different aggressor network entities, or different receive beams of a victim network entity. Additionally, or alternatively, different hypotheses may be associated with different interference measurement resources (IMR) over which CLI is measured. In some examples, the determined CLI information may include a channel quality indicator (CQI), a rank indicator (RI), a precoding matrix indicator (PMI), a signal to interference plus noise ratio (SINR), a reference signal receive power (RSRP), a received signal strength indicator (RSSI), or any combination thereof. In some examples, the CLI information of the CLI report may be included with a channel state information (CSI) report or may be reported separately. The second network entity, upon receiving the CLI report, may determine a hypothesis associated with a desired amount of CLI (e.g., CLI below a threshold amount) and may adjust one or more aspects of wireless communications accordingly (e.g., parameters of the first and/or third network entities).

Aspects of the disclosure are initially described in the context of wireless communications systems. Additional aspects of the disclosure are described in the context of a process flow. Aspects of the disclosure are further illustrated by and described with reference to apparatus diagrams, system diagrams, and flowcharts that relate to cross-link interference report with multiple hypotheses.

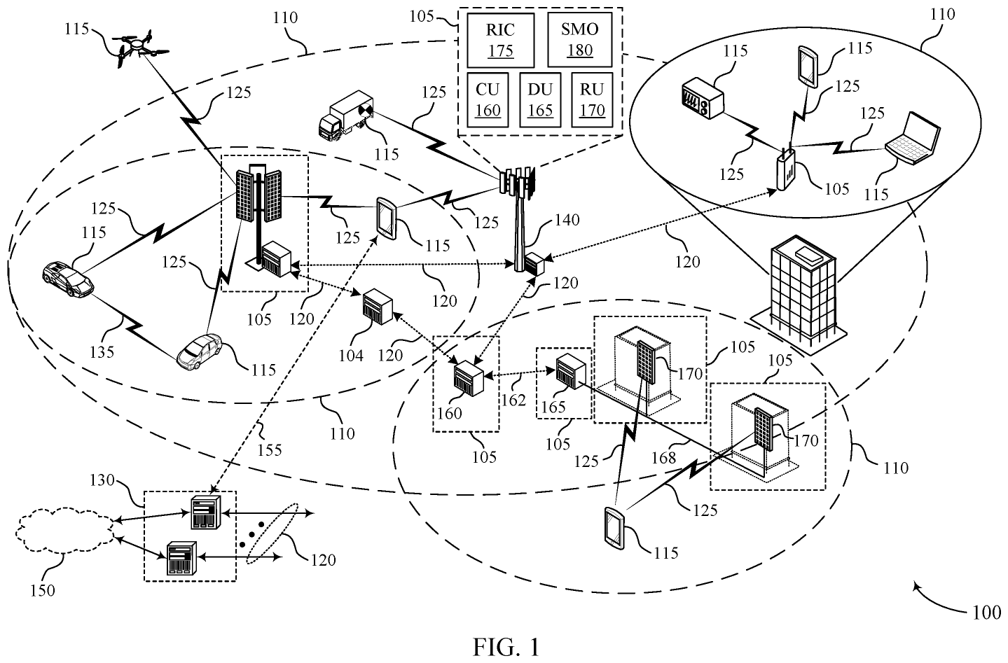

FIG. 1 shows an example of a wireless communications system 100 that supports cross-link interference report with multiple hypotheses in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support cross-link interference report with multiple hypotheses as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A first UE 115 receiving a message from a network entity (e.g., a base station, a UE) may experience CLI from another transmission, where the other transmission may originate from a second UE 115 or from the first UE. If the other transmission originates from the first UE, it may be referred to as self-interference. As a power of the CLI increases over a set of resources over which the message is received, the first UE 115 may have a decreased likelihood of successfully decoding the first message. Techniques that decrease CLI or maintain CLI below a threshold value may enable the first UE 115 to be more likely to successfully decode the first message and, thus, may increase the efficiency of wireless communications.

The present disclosure describes techniques that enable CLI to be decreased or maintained below the threshold value. For instance, the first UE 115 may generate a CLI report that includes CLI information for multiple hypotheses, where each hypothesis corresponds to a respective condition under which values of parameters associated with CLI are determined. For instance, the values of these parameters may be determined assuming different backoff transmit powers for the UE 115 transmitting the other transmission or by measuring different transmit beams of the UE 115 transmitting the other transmission, transmit beams of different UEs, or different receive beams of the first UE. Additionally, or alternatively, different hypotheses may be associated with different IMRs over which CLI is measured. In some examples, the determined CLI information may include a CQI, a PMI, an RI, a SINR, an RSRP, an RSSI, or any combination thereof. In some examples, the CLI information of the CLI report may be included with a CSI report or may be reported separately. The network entity, upon receiving the CLI report, may determine a hypothesis associated with a desired amount of CLI (e.g., CLI below a threshold amount) and may adjust one or more aspects of wireless communications accordingly (e.g., parameters of the first and/or second UE 115).

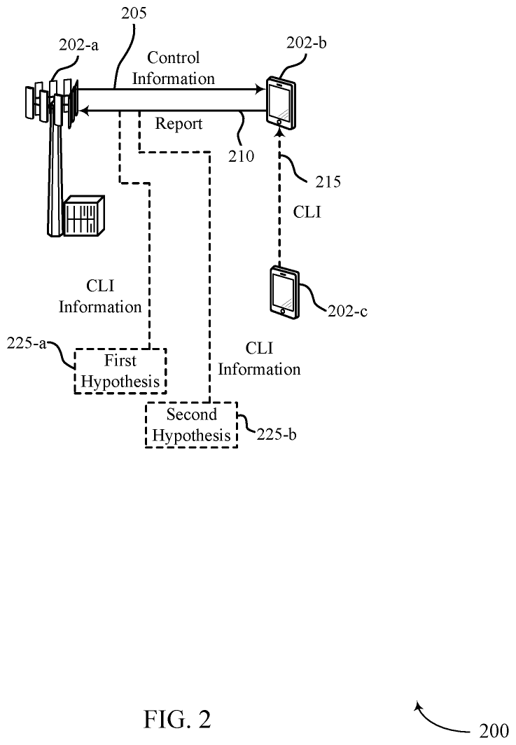

FIG. 2 shows an example of a wireless communications system 200 that supports cross-link interference report with multiple hypotheses in accordance with one or more aspects of the present disclosure. In some examples, wireless communications system 200 may implement one or more aspects of FIG. 1. For instance, network entities 202-a through 202-c may each be an example of a network entity 105 as described with reference to FIG. 1 or a UE 115 as described with reference to FIG. 1.

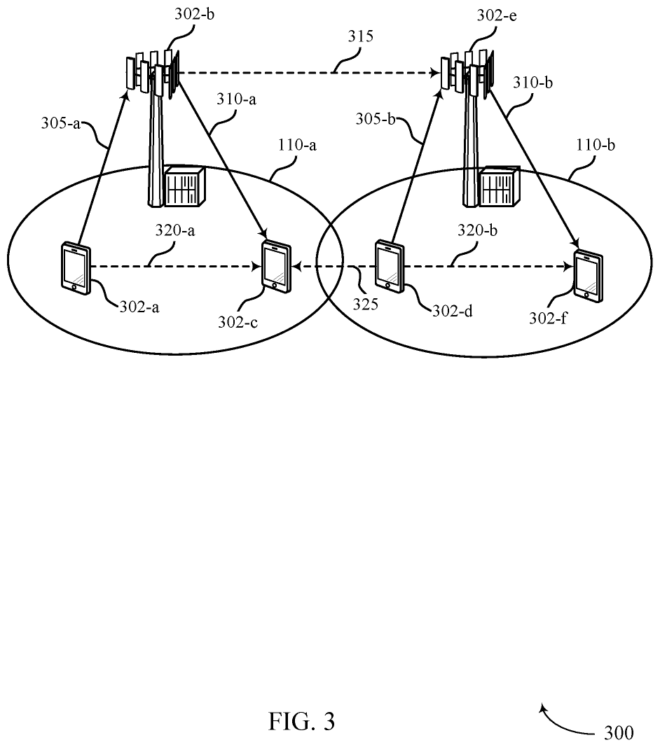

In some examples, network entity 202-a may transmit control information 205 to network entity 202-b. Control information 205 may include first information that is indicative of one or more IMRs for measurement of CLI and/or may include second information indicative of a set of hypotheses (e.g., first hypothesis 225-a and second hypothesis 225-b) for one or more CLI determinations. Each hypothesis of the set of hypotheses may correspond to a respective condition under which values of parameters associated with CLI are determined. Additionally, network entity 202-c may transmit a message that acts as CLI 215 when received by network entity 202-b. In such examples, network entity 202-c may act as an aggressor UE (e.g., a UE that is a source of interference) and network entity 202-b may act as a victim UE (e.g., a UE that is a receiver of interference). Additional details about sources and receivers of CLI be described herein, for instance, with reference to FIG. 3.

Network entity 202-b may generate a CLI report 210 that includes respective CLI information for each hypothesis of two or more of the set of hypotheses (e.g., a subset of the set of hypotheses). For instance, the report may include first CLI information for first hypothesis 225-a and second CLI information for hypothesis 225-b. The first and second CLI information may include values of parameters (e.g., CQI, RI, PMI, SINR, CLI RSRP, CLI RSSI) determined according to their respective hypotheses. In some examples, the respective CLI information for each hypothesis of the two or more hypotheses may be based on the first information indicative of the one or more IMRs. Network entity 202-b may transmit the CLI report 210 to network entity 202-a.

For instance, in a first example, first hypothesis 225-a may be associated with a first sub-configuration in which no CLI resource is configured and second hypothesis 225-b may be associated with a second sub-configuration in which an IMR is configured. In such examples, network entity 202-b may determine values of parameters (e.g., CQI, RI, PMI, SINR) for first hypothesis 225-a without accounting for CLI 215 (e.g., without measuring CLI 215 over an IMR). Additionally, network entity 202-b may determine values of parameters (e.g., CQI, RI, PMI, SINR, CLI RSRP, CLI RSSI) for second hypothesis 225-b while accounting for CLI 215 (e.g., by measuring CLI 215 over an IMR). Interference may be captured based on a configuration of network entity 202-a (e.g., inter-cell interference, inter-beam interference for MU-MIMO). In some examples, the first sub-configuration in which no IMR is configured may be optional. For instance, network entity 202-a may configure whether the CLI report 210 is to include first hypothesis 225-a associated with the first sub-configuration.

In a second example, first hypothesis 225-a may be associated with a first sub-configuration in which a first transmit power backoff value (e.g., an uplink transmit power backoff value) is used and second hypothesis 225-b may be associated with a second hypothesis in which a second transmit power backoff value (e.g., a second uplink transmit power backoff value) is used. In such examples, network entity 202-b may determine values of parameters for first hypothesis 225-a while applying the first transmit power backoff value and may determine the values of parameters for second hypothesis 225-b while applying the second transmit power backoff value.

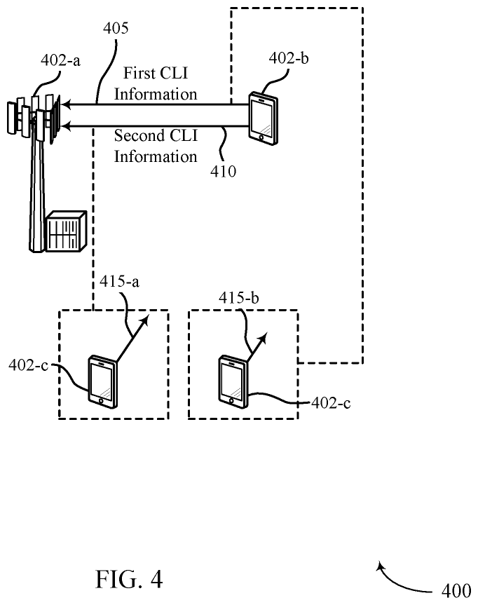

In yet another instance of the second example, CLI report 210 (e.g., a single combined CSI and CLI report) may be configured with multiple transmit power backoff values for CLI calculations and/or hypotheses for the CLI report 210. For instance, a first hypothesis of the set of hypotheses may be associated with a first sub-configuration in which one CLI resource (e.g., one IMR) to measure a first transmit beam of network entity 202-c via a first receive beam of network entity 202-b with no transmit power backoff is configured or a 0 dB transmit power backoff is configured. Additionally, a second hypothesis of the set of hypotheses may be associated with a second sub-configuration in which one CLI resource to measure the first transmit beam of network entity 202-c via the first receive beam of network entity 202-b with a first transmit power backoff value (e.g., 3 dB) is configured. Additionally, a third hypothesis of the set of hypotheses may be associated with a third sub-configuration in which one CLI resource to measure the first transmit beam of network entity 202-c via the first receive beam of network entity 202-b with a second transmit power backoff value (e.g., 5 dB) is configured. In some examples, fourth hypothesis of the set of hypotheses may not be associated with a CLI resource (e.g., the parameter values for the fourth hypothesis may be determined without accounting for CLI). In such examples, multiple CQIs capturing CLI as interference or multiple CLI RSRPs and/or RSSIs may be calculated based on no CLI impact (e.g., the fourth hypothesis), with CLI impact with no power back off (e.g., the first hypothesis), with 3 dB of power back off (e.g., the second hypothesis), and with 5 dB of power back off (e.g., the third hypothesis). In some examples, whether CQI. CLI RSRP, or CLI RSSI is reported may depend on a reportQuantity configuration. With this information, network entity 202-a may determine the CLI impact and may determine a transmit power backoff value that network entity 202-c is to use when transmitting messages. Additional details about hypotheses associated with different transmit power backoff values may be described herein, for instance, with reference to FIG. 4.

In some examples, one IMR resource may be configured for CLI measurement, in which case network entity 202-b may apply multiple (e.g., two) different transmit power backoff values in two calculations and may generate multiple (e.g., two) hypotheses for CLI report 210 based on the single IMR. In other examples, multiple (e.g., two, N) IMR resources may be configured for CLI measurement, in which case network entity 202-b may measure multiple (two, N) transmit power backoff values via the multiple IMR resources and may generate multiple (two, N) hypotheses for CLI report 210. In some examples, network entity 202-a and/or network entity 202-b may use a UE capability indicating a maximum number of CLI RSRP and/or CLI RSSI measurement resources per slot to configure sub-configurations and/or hypotheses.

In some examples, network entity 202-a may provide signaling to configure the transmit power backoff value in a CLI resource configuration for network entity 202-c (e.g., a SRS resource configuration). In some examples, network entity 202-a may provide signaling to configure the transmit power backoff value in a CLI resource configuration for network entity 202-b.

In a third example, first hypothesis 225-a may be associated with measuring a first transmit beam of network entity 202-c and second hypothesis 225-b may be associated with measuring a second transmit beam of network entity 202-c. In such examples, network entity 202-b may determine values for parameters of hypothesis 225-a while measuring CLI 215 from the first transmit beam of network entity 202-c and may determine the values of parameters for second hypothesis 225-b while measuring CLI 215 from the second transmit beam of network entity 202-c.

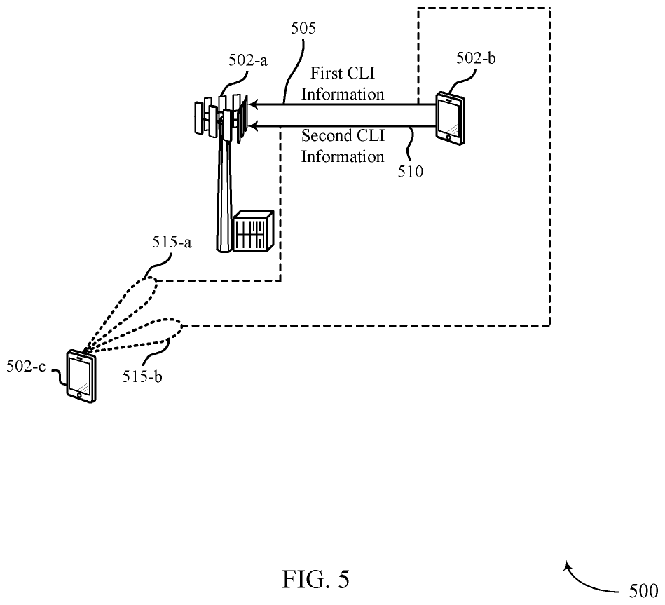

In another instance of the third example, CLI report 210 (e.g., a single combined CSI and CLI report) may be configured with multiple CLI IMRs for CLI corresponding to multiple transmit beams of network entity 202-c for CLI calculations and/or hypotheses for the CLI report 210. For instance, a first hypothesis of the set of hypotheses may be associated with a first sub-configuration with one CLI resource to measure a first transmit beam of network entity 202-c via a first receive beam of network entity 202-b and a first IMR. Additionally, a second hypothesis of the set of hypotheses may be associated with the first sub-configuration with one CLI resource to measure a second transmit beam of network entity 202-c via the first receive beam of network entity 202-b and a second IMR. In some examples, a third hypothesis of the set of hypotheses may not be associated with a CLI resources (e.g., the parameter values for the third hypothesis may be determined without measuring or accounting for CLI). In such examples, multiple CQIs capturing CLI as interference or multiple CLI RSRPs and/or RSSIs may be calculated based on no CLI impact (e.g., the third hypothesis), with CLI impact via measuring the first transmit beam of network entity 202-c (e.g., the first hypothesis), and with CLI impact via measuring the second transmit beam of network entity 202-c (e.g., the second hypothesis). Additional details about hypotheses associated with different transmit beams of a single aggressor UE may be described herein, for instance, with reference to FIG. 5.

In a fourth example, first hypothesis 225-a may be associated with measuring CLI 215 using a first receive beam of network entity 202-b and second hypothesis 225-b may be associated with measuring CLI 215 using a second receive beam of network entity 202-b. In such examples, network entity 202-b may determine values for parameters of hypothesis 225-a while measuring CLI 215 using the first receive beam of network entity 202-b and may determine the values of parameters for second hypothesis 225-b while measuring CLI 215 using the second receive beam of network entity 202-b.

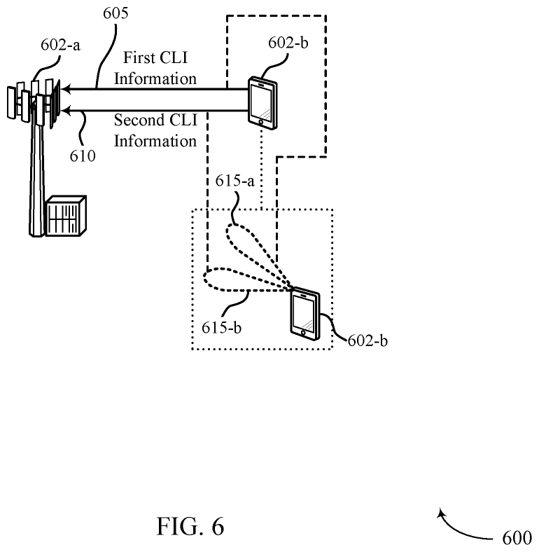

In another instance of the fourth example, CLI report 210 (e.g., a single combined CSI and CLI report) may be configured with multiple CLI IMRs for CLI corresponding to multiple receive beams of network entity 202-b for CLI calculations and/or hypotheses for the CLI report 210, where the CLI 215 may correspond to multiple receive beams via quasi co-location (QCL) type D per receive CLI resource configurations. For instance, a first hypothesis of the set of hypotheses may be associated with a first sub-configuration with one CLI resource to measure a first transmit beam of network entity 202-c via a first receive beam of network entity 202-b and a first IMR. Additionally, a second hypothesis of the set of hypotheses may be associated with the first sub-configuration with one CLI resource to measure the first transmit beam of network entity 202-c via a second receive beam of network entity 202-b and a second IMR. In some examples, a third hypothesis of the set of hypotheses may not be associated with a CLI resources (e.g., the parameter values for the third hypothesis may be determined without measuring or accounting for CLI). In such examples, multiple CQIs capturing CLI as interference or multiple CLI RSRPs and/or RSSIs may be calculated based on no CLI impact (e.g., the third hypothesis), with CLI impact via measuring using the first receive beam of network entity 202-b (e.g., the first hypothesis), and with CLI impact via measuring using the second receive beam of network entity 202-b (e.g., the second hypothesis). Additional details about hypotheses associated with different receive beams of a victim UE may be described herein, for instance, with reference to FIG. 6.

In a fifth example, first hypothesis 225-a may be associated with measuring a first transmit beam of network entity 202-c and second hypothesis 225-b may be associated with measuring a second transmit beam of another UE (e.g., another network entity). In such examples, network entity 202-b may determine values for parameters of hypothesis 225-a while measuring CLI 215 from the first transmit beam of network entity 202-c and may determine the values of parameters for second hypothesis 225-b while measuring CLI 215 from the second transmit beam of the other UE.

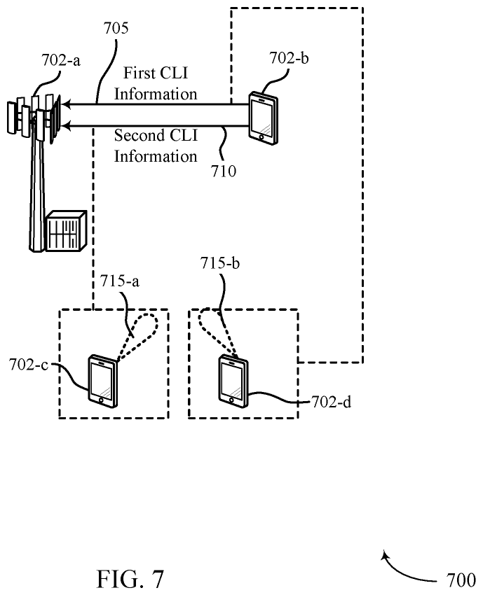

In another instance of the fifth example, CLI report 210 (e.g., a single combined CSI and CLI report) may be configured with multiple CLI IMRs for CLI corresponding to multiple transmit UE IDs (e.g., multiple UEs) for CLI calculations and/or hypotheses for the CLI report 210. For instance, a first hypothesis of the set of hypotheses may be associated with a first sub-configuration with one CLI resource to measure a first transmit beam of network entity 202-c via a first receive beam of network entity 202-b and a first IMR. Additionally, a second hypothesis of the set of hypotheses may be associated with the first sub-configuration with one CLI resource to measure a second transmit beam of the other UE via the first receive beam of network entity 202-b and a second IMR. In some examples, a third hypothesis of the set of hypotheses may not be associated with a CLI resources (e.g., the parameter values for the third hypothesis may be determined without measuring or accounting for CLI). In such examples, multiple CQIs capturing CLI as interference or multiple CLI RSRPs and/or RSSIs may be calculated based on no CLI impact (e.g., the third hypothesis), with CLI impact via measuring the first transmit beam of network entity 202-c (e.g., the first hypothesis), and with CLI impact via measuring the second transmit beam of the other UE (e.g., the second hypothesis). Additional details about hypotheses associated with transmit beams of different aggressor UEs be described herein, for instance, with reference to FIG. 7.

In a sixth example, first hypothesis 225-a may be associated with a first IMR and second hypothesis 225-b may be associated with a second IMR and/or the first IMR. In such examples, network entity 202-b may determine values for parameters of hypothesis 225-a while measuring CLI 215 over the first IMR and may determine the values of parameters for second hypothesis 225-b while measuring CLI 215 over a second IMR and/or the first IMR.

In another instance of the sixth example, CLI report 210 (e.g., a single combined CSI and CLI report) may be configured with multiple sub-configurations or hypotheses. If two IMRs (e.g., a first IMR and a second IMR) for CLI are configured (e.g., associated with two beams of network entity 202-c or a beam of network entity 202-c and a beam of another network entity), multiple hypotheses may be calculated and/or generated. In examples in which CQI is used as a report quantity (e.g., indicated via reportQuantity), a first CQI may be calculated using both the first IMR and the second IMR, a second CQI may be calculated using only the first IMR, and a third CQI may be calculated with the second IMR. Similar techniques may be performed with SINR, CLI RSRP, or CLI RSSI instead of or along with CQI without deviating from the scope of the present disclosure. In some examples, each of the first, second, and third CQI may correspond to a separate hypotheses. Additionally, or alternatively, the first, second, and third CQI may be included in CLI report 210.

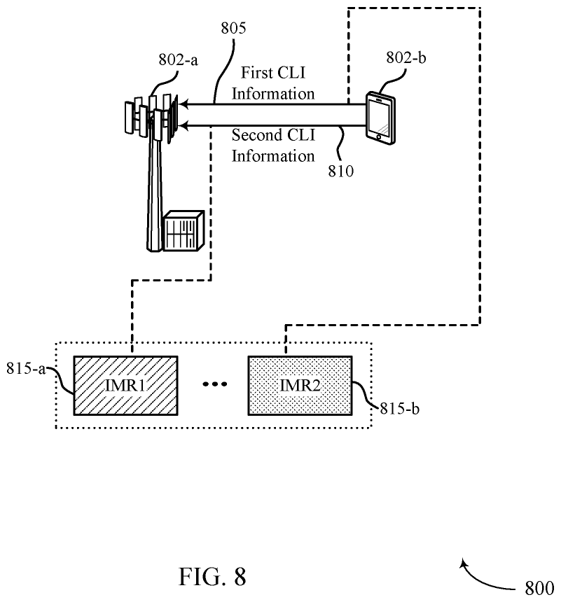

In yet another instance of the sixth example, if two IMRs are configured for CLI and each IMR is associated with two configured power control backoff values (e.g., uplink power control backoff values), then multiple hypotheses may be calculated and/or generated. For instance, the two IMRs may include a first IMR and a second IMR and the two configured power control backoff values may include a first power control backoff value and a second power control backoff value. In examples in which CQI is used as a report quantity (e.g., indicated via reportQuantity), a first CQI may be calculated using the first power control backoff value and only the first IMR; a second CQI may be calculated using the second power control backoff value and only the first IMR; a third CQI may be calculated using the first power control backoff value and only the second IMR; a fourth CQI may be calculated using the second power control backoff value and only the second IMR; a fifth CQI may be calculated using both the first and second IMRs and the first power control backoff value for both IMRs; a sixth CQI may be calculated using both the first and second IMRs and the second power control backoff value for both IMRs; a seventh CQI may be calculated using both the first and second IMRs and the first power control backoff value for the first IMR and the second power control backoff value for the second IMR; and an eighth CQI may be calculated using both the first and second IMRs and the second power control backoff value for the first IMR and the first power control backoff value for the first IMR. Similar techniques may be performed with SINR, CLI RSRP, or CLI RSSI instead of or along with CQI without deviating from the scope of the present disclosure. In some examples, each of the first through eighth CQI may correspond to a separate hypotheses. Additionally, or alternatively, the first through the eight CQI may be included in CLI report 210. Additional details about hypotheses associated with different IMRs may be described herein, for instance, with reference to FIG. 8.

In some examples, to reduce overhead, a subset of the set of hypotheses may be reported to network entity 202-a. For instance, if multiple IMRs are configured per aggressor UE (e.g., network entity 202-c), the victim UE (e.g., network entity 202-b) may report the most or least interfering (e.g., the top N most or least interfering) CLI resources for each aggressor UE. For instance, network entity 202-b may report a first IMR corresponding to a first aggressor UE and a second IMR corresponding to a second aggressor UE.

In some examples, performing the techniques described herein may have one or more advantages. For instance, network entity 202-b transmitting a CLI report 210 that includes multiple hypotheses may enable network entity 202-a to adjust aspects of wireless communications to conform with a hypothesis that is associated with a desired amount of CLI (e.g., an amount of CLI below a threshold amount). For instance, network entity 202-a may adjust parameters to match the values of those parameters in a particular hypothesis (e.g., beams of network entity 202-b and/or network entity 202-c or a transmit power backoff value associated with network entity 202-c). With a smaller amount of CLI, the efficiency of wireless communications may decrease.

FIG. 3 shows an example of a wireless communications system 300 that supports cross-link interference report with multiple hypotheses in accordance with one or more aspects of the present disclosure. In some examples, wireless communications system 300 may implement one or more aspects of FIGS. 1 and 2. For instance, network entities 302-a through 302-f may each be an example of a UE 115 as described with reference to FIG. 1; network entity as described with reference to FIG. 1; or one of network entities 202-a through 202-c as described with reference to FIG. 2. Additionally, coverage areas 110-a and 110-b may each be an example of a coverage area 110 as described with reference to FIG. 1.

Network entities 302-a and 302-c may be within a coverage area 110-a associated with network entity 302-b and network entities 302-d and 302-f may be in a coverage area 110-b associated with network entity 302-e. In some examples, network entity 302-a may transmit a first message 305-a towards network entity 302-b and network entity 302-c may receive a second message 310-a from network entity 302-b. Additionally, network entity 302-d may transmit a third message 305-b towards network entity 302-e and network entity 302-f may receive a fourth message 310-b from network entity 302-e. Although first message 305-a may be directed towards network entity 302-b, a component of first message 305-a may be received at network entity 302-c and may interfere with the second message 310-a as CLI 320-a. Similarly, although third message 305-b may be directed towards network entity 302-e, a component of third message 305-b may be received at network entity 302-f and may interfere with fourth message 310-b as CLI 320-b. Additionally, another component of third message 305-b may be received at network entity 302-c and may interfere with second message 310-a as CLI 325. In some examples, a component of second message 310-a may be received at network entity 302-e and may interfere with third message 305-b as CLI 315. In examples in which network entities 302-a. 302-c. 302-d, and 302-f are UEs, CLI 320-a and 320-b may each be referred to as intra-cell inter-UE CLI, CLI 325 may be referred to as inter-cell inter-UE CLI, and CLI 315 may be referred to as inter-network-entity CLI.

In some examples, network entities 302-a and 302-c may operate in a sub-band full duplex (SBFD) mode with network entity 302-b. For instance, transmissions toward network entity 302-b (e.g., first message 305-a) may be scheduled over a first set of frequency resources (e.g., a first set of sub-bands) that overlap in time with (e.g., occur in a same slot as) a second set of frequency resources (e.g., a second set of sub-bands) scheduled for transmissions from network entity 302-b (e.g., second message 310-a). The first set of frequency resources may completely exclude the second set of frequency resources, may partially overlap with the second set of frequency resources, or may fully overlap with the second set of frequency resources. In examples in which the first and second set of frequency resources completely exclude each other, CLI 315, 320-a, 320-b, and 325 may be referred to as inter-sub-band CLI. However, in examples in which the first and second set of frequency resources at least partially overlap, CLI 315, 320-a, 320-b, and 325 may include one or both of inter-sub-band CLI and in-band CLI. In some examples, network entities 302-a and 302-c may operate in a dynamic and/or flexible time division duplexing (TDD) mode, in which case the techniques described herein may be applied without deviating from the scope of the present disclosure. Additionally, in examples in which network entity 302-b and/or network entity 302-e is a UE, the techniques described herein may be used for UE SBFD and/or UE partial or fully overlapping frequency duplexing.

The techniques described herein may mitigate CLI between UEs, such as CLI 320-a, 320-b, and 325. For instance, network entity 302-c may receive first information indicative of one or more IMRs for measurement of CLI and second information indicative of a set of hypotheses for one or more CLI determinations. Network entity 302-c may measure CLI over the one or more IMRs and may generate, according to the set of hypotheses, a CLI report including CLI information for at least a subset of the set of hypotheses. Network entity 302-c may provide the CLI report to network entity 302-b and network entity 302-b may determine a hypothesis associated with a desired amount of CLI (e.g., CLI below a threshold amount) and may adjust one or more aspects of wireless communications accordingly. For instance, network entity 302-b may adjust parameters (e.g., transmit power backoff values, beams) associated with communicating with network entity 302-a and/or network entity 302-c and may provide an indication of those parameters to network entity 302-a and/or network entity 302-c.

FIG. 4 shows an example of a wireless communications system 400 that supports cross-link interference report with multiple hypotheses in accordance with one or more aspects of the present disclosure. In some examples, wireless communications system 400 may implement one or more aspects of FIGS. 1 through 3. For instance, network entities 402-a through 402-c may each be an example of a UE 115 as described with reference to FIG. 1; network entity as described with reference to FIG. 1; one of network entities 202-a through 202-c as described with reference to FIG. 2; or one of network entities 302-a through 302-f as described with reference to FIG. 3.

As depicted in FIG. 4, network entity 402-b may transmit a CLI report to network entity 402-a that includes first CLI information 405 and second CLI information 410. In some examples, the first CLI information 405 may correspond to a first hypothesis and second CLI information 410 may correspond to a second hypothesis. For instance, a first hypothesis may be associated with a first sub-configuration in which a first transmit power backoff value 415-a (e.g., a first uplink transmit power backoff value) for network entity 402-c is configured and a second hypothesis may be associated with a second sub-configuration in which a second transmit power backoff value 415-b (e.g., a second uplink transmit power backoff value) is configured. In such examples, network entity 402-b may determine CLI information 405 for the first hypothesis while applying the first transmit power backoff value 415-a and may determine the second CLI information 410 while applying the second transmit power backoff value 415-b.

FIG. 5 shows an example of a wireless communications system 500 that supports cross-link interference report with multiple hypotheses in accordance with one or more aspects of the present disclosure. In some examples, wireless communications system 500 may implement one or more aspects of FIGS. 1 through 4. For instance, network entities 502-a through 502-c may each be an example of a UE 115 as described with reference to FIG. 1; network entity as described with reference to FIG. 1; one of network entities 202-a through 202-c as described with reference to FIG. 2; one of network entities 302-a through 302-f as described with reference to FIG. 3; or one of network entities 402-a through 402-c as described with reference to FIG. 4.

As depicted in FIG. 5, network entity 502-b may transmit a CLI report to network entity 502-a that includes first CLI information 505 and second CLI information 510. In some examples, the first CLI information 505 may correspond to a first hypothesis and second CLI information 510 may correspond to a second hypothesis. For instance, the first hypothesis may be associated with measuring a first transmit beam 515-a of network entity 502-c and the second hypothesis may be associated with measuring a second transmit beam 515-b of network entity 502-c. In such examples, network entity 502-b may determine first CLI information 505 for the first hypothesis while measuring CLI from first transmit beam 515-a of network entity 502-c and may determine second CLI information 510 while measuring CLI from second transmit beam 515-b of network entity 502-c.

FIG. 6 shows an example of a wireless communications system 600 that supports cross-link interference report with multiple hypotheses in accordance with one or more aspects of the present disclosure. In some examples, wireless communications system 600 may implement one or more aspects of FIGS. 1 through 5. For instance, network entities 602-a and 602-b may each be an example of a UE 115 as described with reference to FIG. 1; network entity as described with reference to FIG. 1; one of network entities 202-a through 202-c as described with reference to FIG. 2; one of network entities 302-a through 302-f as described with reference to FIG. 3; one of network entities 402-a through 402-c as described with reference to FIG. 4; or one of network entities 502-a through 502-c as described with reference to FIG. 5.

As depicted in FIG. 6, network entity 602-b may transmit a CLI report to network entity 602-a that includes first CLI information 605 and second CLI information 610. In some examples, the first CLI information 605 may correspond to a first hypothesis and second CLI information 610 may correspond to a second hypothesis. For instance, the first hypothesis may be associated with measuring CLI using a first receive beam 615-a of network entity 602-b and the second hypothesis may be associated with measuring CLI using a second receive beam 615-b of network entity 602-b. In such examples, network entity 602-b may determine first CLI information 605 for the first hypothesis while measuring CLI using the first receive beam 615-a of network entity 602-b and may determine second CLI information 610 for the second hypothesis while measuring CLI using the second receive beam 615-b of network entity 602-b.

FIG. 7 shows an example of a wireless communications system 700 that supports cross-link interference report with multiple hypotheses in accordance with one or more aspects of the present disclosure. In some examples, wireless communications system 700 may implement one or more aspects of FIGS. 1 through 6. For instance, network entities 702-a through 702-d may each be an example of a UE 115 as described with reference to FIG. 1; network entity as described with reference to FIG. 1; one of network entities 202-a through 202-c as described with reference to FIG. 2; one of network entities 302-a through 302-f as described with reference to FIG. 3; one of network entities 402-a through 402-c as described with reference to FIG. 4; one of network entities 502-a through 502-c as described with reference to FIG. 5; or one of network entities 602-a and 602-b as described with reference to FIG. 6.

As depicted in FIG. 7, network entity 702-b may transmit a CLI report to network entity 702-a that includes first CLI information 705 and second CLI information 710. In some examples, a first hypothesis may be associated with measuring a first transmit beam 715-a of network entity 702-c and a second hypothesis may be associated with measuring a second transmit beam 715-b of network entity 702-d. In such examples, network entity 702-b may determine first CLI information 705 for the first hypothesis while measuring CLI from first transmit beam 715-a of network entity 702-c and may determine second CLI information 710 for the second hypothesis while measuring CLI from the second transmit beam 715-b of network entity 702-d

FIG. 8 shows an example of a wireless communications system 800 that supports cross-link interference report with multiple hypotheses in accordance with one or more aspects of the present disclosure. In some examples, wireless communications system 800 may implement one or more aspects of FIGS. 1 through 7. For instance, network entities 802-a and 802-b may each be an example of a UE 115 as described with reference to FIG. 1; network entity as described with reference to FIG. 1; one of network entities 202-a through 202-c as described with reference to FIG. 2; one of network entities 302-a through 302-f as described with reference to FIG. 3; one of network entities 402-a through 402-c as described with reference to FIG. 4; one of network entities 502-a through 502-c as described with reference to FIG. 5; one of network entities 602-a and 602-b as described with reference to FIG. 6; or one of network entities 702-a through 702-d as described with reference to FIG. 7.

As depicted in FIG. 8, network entity 802-b may transmit a CLI report to network entity 802-a that includes first CLI information 805 and second CLI information 810. In some examples, a first hypothesis may be associated with a first IMR 815-a and a second hypothesis may be associated with a second IMR 815-b and/or the first IMR 815-a. In such examples, network entity 802-b may determine first CLI information 805 for the first hypothesis while measuring CLI over the first IMR 815-a and may determine the second CLI information 810 while measuring CLI over the second IMR 815-b and/or the first IMR 815-a.

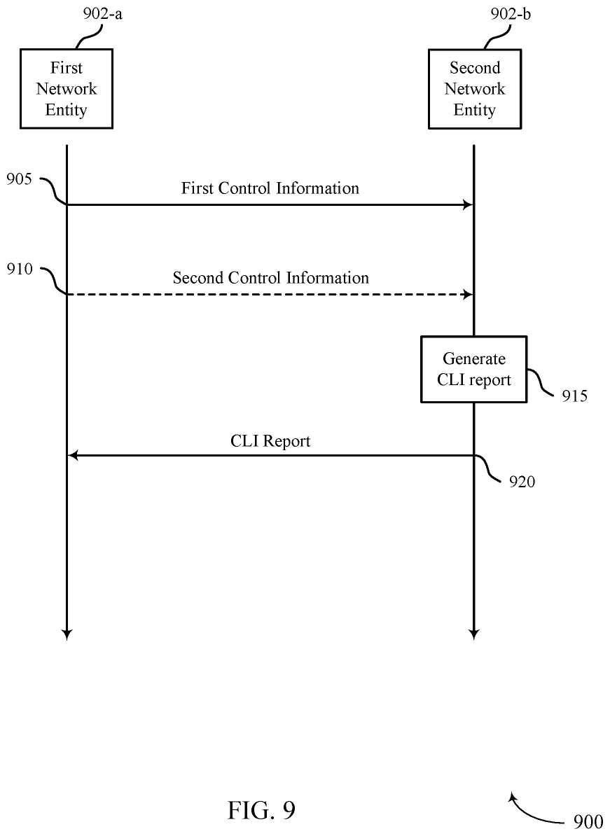

FIG. 9 shows an example of a process flow 900 that supports cross-link interference report with multiple hypotheses in accordance with one or more aspects of the present disclosure. In some examples, process flow 900 may implement one or more aspects of FIGS. 1 through 8. For instance, network entities 902-a and 902-b may each be an example of a UE 115 as described with reference to FIG. 1; network entity as described with reference to FIG. 1; one of network entities 202-a through 202-c as described with reference to FIG. 2; one of network entities 302-a through 302-f as described with reference to FIG. 3; one of network entities 402-a through 402-c as described with reference to FIG. 4; one of network entities 502-a through 502-c as described with reference to FIG. 5; one of network entities 602-a and 602-b as described with reference to FIG. 6; one of network entities 702-a through 702-d as described with reference to FIG. 7; or one of network entities 802-a and 802-b as described with reference to FIG. 8.

At 905, first network entity 902-a transmit first control information, second network entity 902-b may receive the first control information. In some examples, the first control information may include first information and second information, where the first information is indicative of one or more IMRs for measurement of CLI and the second information is indicative of a set of hypotheses for one or more CLI determinations. In some examples, the first control information may be indicated in a report configuration.

At 910, first network entity 902-a may transmit second control information indicative of a first transmit power backoff value and a second transmit power backoff value. In such examples, each of the first transmit power backoff value and the second transmit power backoff value may be equal to or greater than zero.

At 915, second network entity 902-b may generate a CLI report that includes respective CLI information for each hypothesis of two or more of the set of hypotheses, where the respective CLI information for each hypothesis of the two or more hypotheses is based on the first information indicative of the one or more IMRs. In some examples, the two or more hypotheses may include a first hypothesis and a second hypothesis. In some such examples, the respective CLI information for the first hypothesis may include a CQI, an RI, a PMI, or a SINR. Additionally, the first hypothesis may be associated with an absence of CLI measurement and the second hypothesis may be associated with CLI measurement based on the one or more IMRs. Additionally, or alternatively, the first hypothesis may be associated with the first transmit power backoff value and the second hypothesis may be associated with the second transmit power backoff value.

In some examples, at least one IMR of the one or more IMRs may be associated with multiple hypotheses of the two or more hypotheses. Additionally, or alternatively, a first IMR of the one or more IMRs may be associated with the first hypothesis and a second IMR of the one or more IMRs may be associated with the second hypothesis. In some examples, the first hypothesis may be based on the first IMR and the second IMR. In some such examples, the second hypothesis may be based on only the second IMR.

In some examples, the first hypothesis may be associated with a first transmit beam of a third network entity (e.g., a UE, a base station) and a second hypothesis may be associated with a second transmit beam of the third network entity. Additionally, or alternatively, the first hypothesis may be associated with a first receive beam of second network entity 902-b and the second hypothesis may be associated with a second receive beam of second network entity 902-b. Additionally, or alternatively, the first hypothesis may be associated with the third network entity and the second hypothesis may be associated with a fourth network entity (e.g., a UE, a base station).

In some examples, the two or more hypotheses may have a first quantity of hypotheses and the set of hypotheses may have a second quantity of hypotheses, where the first quantity of hypotheses is less than the second quantity of hypotheses. In such examples, second network entity 902-b may determine the two or more hypotheses based on a maximum quantity of hypotheses associated with the report. To determine the two or more hypotheses, second network entity 902-b may select the two or more hypotheses (e.g., from the set of hypotheses). Additionally, second network entity 902-b may generate, based on selecting the two or more hypotheses, the report to include the respective CLI information for each hypothesis of the two or more hypotheses. In some examples, each hypothesis of the two or more hypotheses may be associated with a larger amount of interference relative to each hypothesis of the set of hypotheses that is excluded from the two or more hypotheses or each hypothesis of the two or more hypotheses is associated with a smaller amount of interference relative to each hypothesis of the set of hypotheses that is excluded from the two or more hypotheses.

In some examples, the respective CLI information for each hypothesis of the two or more hypotheses includes a respective CQI, a respective RI, a respective PMI, a respective RSSI, a respective RSRP, or a respective SINR. In some examples, the report may include CSI. In some examples, each CLI determination of the one or more CLI determinations may be associated with the respective CLI information or a respective measurement of CLI for a respective hypothesis of the two or more hypotheses. In some examples, second network entity 902-b may generate, based on the one or more IMRs, the respective CLI information for each hypothesis of the two or more hypotheses. In some such examples, to generate the respective CLI information, second network entity 902-b may measure the one or more IMRs.

In some examples, a first hypothesis of the set of hypotheses is associated with a first interference measurement resource of the one or more interference measurement resources and a second interference measurement resource of the one or more interference measurement resources, a second hypothesis of the set of hypotheses is associated with only the first interference measurement resource, and a third hypothesis of the set of hypotheses is associated with only the second interference measurement resource.

In some examples, a first hypothesis of the set of hypotheses is associated with a first interference measurement resource of the one or more interference measurement resources and a first power control backoff value, a second hypothesis of the set of hypotheses is associated with the first interference measurement resource and a second power control backoff value, a third hypothesis of the set of hypotheses is associated with a second interference measurement resource of the one or more interference measurement resources and the first power control backoff value, and a fourth hypothesis of the set of hypotheses is associated with the second interference measurement resource and the second power control backoff value.

In some examples, a fifth hypothesis of the set of hypotheses is associated with the first power control backoff value for the first interference measurement resource and the first power control backoff value for the second interference measurement resource, a sixth hypothesis of the set of hypotheses is associated with the second power control backoff value for the first interference measurement resource and the second power control backoff value for the second interference measurement resource, a seventh hypothesis of the set of hypotheses is associated with the first power control backoff value for the first interference measurement resource and the second power control backoff value for the second interference measurement resource, and an eighth hypothesis of the set of hypotheses is associated with the second power control backoff value for the first interference measurement resource and the first power control backoff value for the second interference measurement resource.

In some examples, the one or more interference measurement resources include a set of multiple interference measurement resources for each network entity of a set of multiple network entities, where the two or more hypotheses include hypotheses associated with any of N interference measurement resources of the set of multiple interference measurement resources for each network entity of the set of multiple network entities, where the N interference measurement resources are associated with a higher interference than each remaining interference measurement resource of the set of multiple interference measurement resources for each network entity of the set of multiple network entities, and where N is a positive integer.

In some examples, the one or more interference measurement resources include a set of multiple interference measurement resources for each network entity of a set of multiple network entities, where the two or more hypotheses include hypotheses associated with any of N interference measurement resources of the set of multiple interference measurement resources for each network entity of the set of multiple network entities, where the N interference measurement resources are associated with a lower interference than each remaining interference measurement resource of the set of multiple interference measurement resources for each network entity of the set of multiple network entities, and where N is a positive integer.

At 920, second network entity 902-b may transmit, to first network entity 902-a, the CLI report.

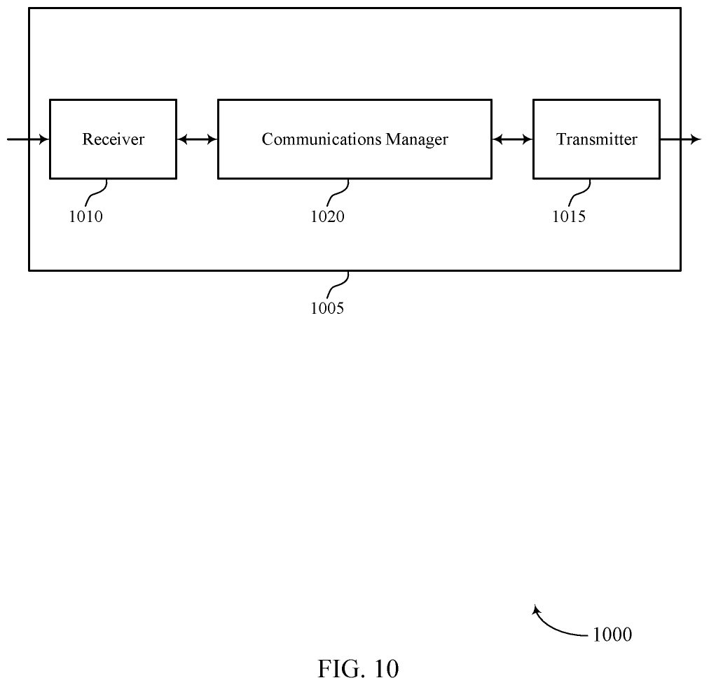

FIG. 10 shows a block diagram 1000 of a device 1005 that supports cross-link interference report with multiple hypotheses in accordance with one or more aspects of the present disclosure. The device 1005 may be an example of aspects of a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to cross-link interference report with multiple hypotheses). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to cross-link interference report with multiple hypotheses). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of cross-link interference report with multiple hypotheses as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication performed in accordance with examples as disclosed herein. For example, the communications manager 1020 is capable of, configured to, or operable to support a means for receiving, from a second network entity, first control information that includes first information and second information, where the first information is indicative of one or more interference measurement resources for measurement of cross-link interference (CLI) and the second information is indicative of a set of multiple hypotheses for one or more CLI determinations. The communications manager 1020 is capable of, configured to, or operable to support a means for transmitting, to the second network entity, a report that includes respective CLI information for each hypothesis of two or more of the set of multiple hypotheses, where the respective CLI information for each hypothesis of the two or more hypotheses is based on the first information indicative of the one or more interference measurement resources.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for a device 1005 to reduce CLI via reporting of multiple hypotheses.

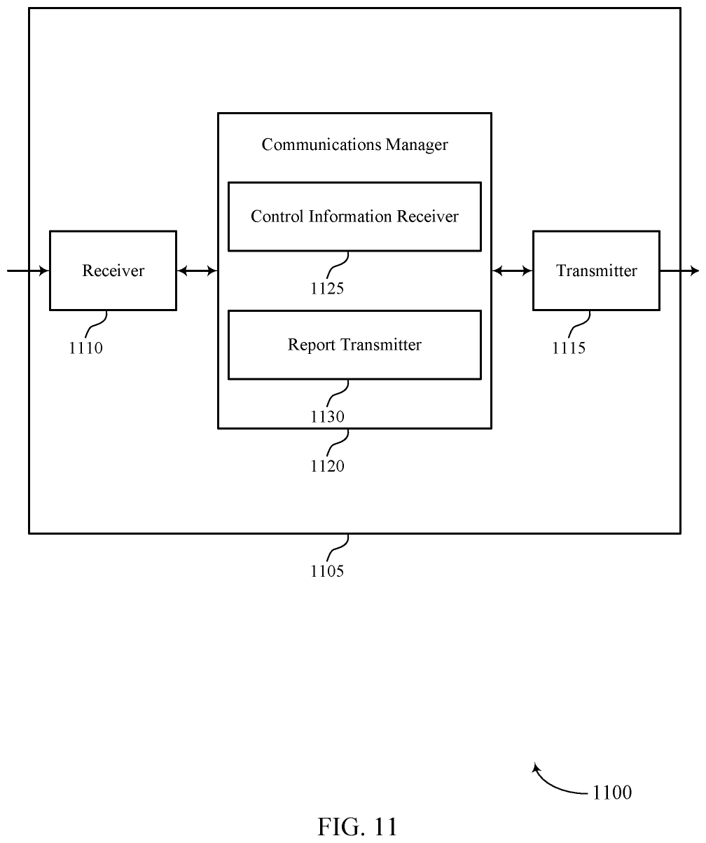

FIG. 11 shows a block diagram 1100 of a device 1105 that supports cross-link interference report with multiple hypotheses in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to cross-link interference report with multiple hypotheses). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to cross-link interference report with multiple hypotheses). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of cross-link interference report with multiple hypotheses as described herein. For example, the communications manager 1120 may include a control information receiver 1125 a report transmitter 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication performed in accordance with examples as disclosed herein. The control information receiver 1125 is capable of, configured to, or operable to support a means for receiving, from a second network entity, first control information that includes first information and second information, where the first information is indicative of one or more interference measurement resources for measurement of cross-link interference (CLI) and the second information is indicative of a set of multiple hypotheses for one or more CLI determinations. The report transmitter 1130 is capable of, configured to, or operable to support a means for transmitting, to the second network entity, a report that includes respective CLI information for each hypothesis of two or more of the set of multiple hypotheses, where the respective CLI information for each hypothesis of the two or more hypotheses is based on the first information indicative of the one or more interference measurement resources.

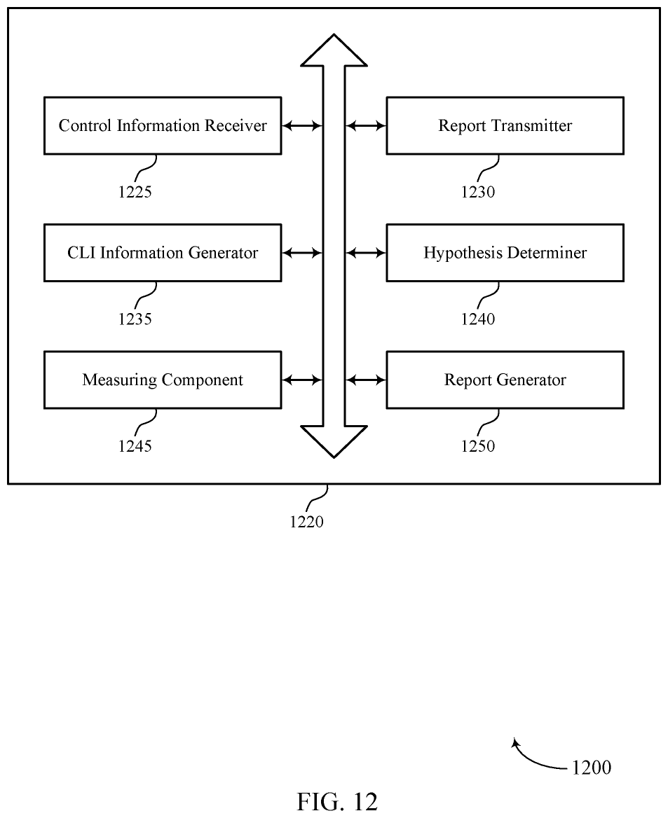

FIG. 12 shows a block diagram 1200 of a communications manager 1220 that supports cross-link interference report with multiple hypotheses in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of cross-link interference report with multiple hypotheses as described herein.

For example, the communications manager 1220 may include a control information receiver 1225, a report transmitter 1230, a CLI information generator 1235, a hypothesis determiner 1240, a measuring component 1245, a report generator 1250, or any combination thereof. Each of these components, or components or subcomponents thereof (e.g., one or more processors, one or more memories), may communicate, directly or indirectly, with one another (e.g., via one or more buses).

The communications manager 1220 may support wireless communication performed in accordance with examples as disclosed herein. The control information receiver 1225 is capable of, configured to, or operable to support a means for receiving, from a second network entity, first control information that includes first information and second information, where the first information is indicative of one or more interference measurement resources for measurement of cross-link interference (CLI) and the second information is indicative of a set of multiple hypotheses for one or more CLI determinations. The report transmitter 1230 is capable of, configured to, or operable to support a means for transmitting, to the second network entity, a report that includes respective CLI information for each hypothesis of two or more of the set of multiple hypotheses, where the respective CLI information for each hypothesis of the two or more hypotheses is based on the first information indicative of the one or more interference measurement resources.

In some examples, the two or more hypotheses include a first hypothesis and a second hypothesis. In some examples, the respective CLI information for the first hypothesis includes a channel quality indicator (CQI), a rank indicator (RI), a precoding matrix indicator (PMI), or a signal to interference plus noise ratio (SINR). In some examples, the first hypothesis is associated with an absence of CLI measurement and the second hypothesis that is associated with CLI measurement based on the one or more interference measurement resources.

In some examples, the two or more hypotheses include a first hypothesis associated with a first transmit power backoff value and a second hypothesis associated with a second transmit power backoff value. In some examples, each of the first transmit power backoff value and the second transmit power backoff value are equal to or greater than zero.

In some examples, the control information receiver 1225 is capable of, configured to, or operable to support a means for receiving, from the second network entity, second control information indicative of the first transmit power backoff value and the second transmit power backoff value.

In some examples, at least one interference measurement resource of the one or more interference measurement resources is associated with multiple hypotheses of the two or more hypotheses.

In some examples, a first interference measurement resource of the one or more interference measurement resources is associated with a first hypothesis of the two or more hypotheses and a second interference measurement resource of the one or more interference measurement resources is associated with a second hypothesis of the two or more hypotheses.

In some examples, a first hypothesis of the two or more hypotheses is based on a first interference measurement resource of the one or more interference measurement resources and a second interference measurement resource of the one or more interference measurement resources.

In some examples, a second hypothesis of the two or more hypotheses is based on only one of the first interference measurement resource or the second interference measurement resource.

In some examples, the first hypothesis is associated with a first transmit power backoff value and the second hypothesis is associated with a second transmit power backoff value.

In some examples, the two or more hypotheses include a first hypothesis associated with a first transmit beam of a third network entity and a second hypothesis associated with a second transmit beam of the third network entity.

In some examples, the two or more hypotheses include a first hypothesis associated with a CLI measurement associated with a first receive beam of the first network entity and a second hypothesis associated with a second receive beam of the first network entity.

In some examples, the two or more hypotheses include a first hypothesis associated with a third network entity and a second hypothesis associated with a fourth network entity.

In some examples, the two or more hypotheses has a first quantity of hypotheses and the set of multiple hypotheses has a second quantity of hypotheses. In some examples, the first quantity of hypotheses is less than the second quantity of hypotheses.

In some examples, the hypothesis determiner 1240 is capable of, configured to, or operable to support a means for determining the two or more hypotheses based on a maximum quantity of hypotheses associated with the report.

In some examples, to support determining the two or more hypotheses based on maximum quantity of hypotheses associated with the report, the hypothesis determiner 1240 is capable of, configured to, or operable to support a means for selecting the two or more hypotheses.

In some examples, the report generator 1250 is capable of, configured to, or operable to support a means for generating, based on selecting the two or more hypotheses, the report to include the respective CLI information for each hypothesis of the two or more hypotheses.

In some examples, each hypothesis of the two or more hypotheses is associated with a larger amount of interference relative to each hypothesis of the set of multiple hypotheses that is excluded from the two or more hypotheses or each hypothesis of the two or more hypotheses is associated with a smaller amount of interference relative to each hypothesis of the set of multiple hypotheses that is excluded from the two or more hypotheses.

In some examples, the respective CLI information for each hypothesis of the two or more hypotheses includes a respective channel quality indicator (CQI), a respective rank indicator (RI), a respective precoding matrix indicator (PMI), a respective received signal strength indicator (RSSI), a respective reference signal receive power (RSRP), or a respective signal to interference plus noise ratio (SINR). In some examples, the report includes channel state information.

In some examples, the first control information is indicated in a report configuration.

In some examples, each CLI determination of the one or more CLI determinations is associated with the respective CLI information or a respective measurement of CLI for a respective hypothesis of the two or more hypotheses.

In some examples, the CLI information generator 1235 is capable of, configured to, or operable to support a means for generating, based on the one or more interference measurement resources, the respective CLI information for each hypothesis of the two or more hypotheses.

In some examples, to support generating, based on the one or more interference measurement resources, the respective CLI information for each hypothesis of the one or more hypotheses, the measuring component 1245 is capable of, configured to, or operable to support a means for measuring the one or more interference measurement resources.

In some examples, a first hypothesis of the set of multiple hypotheses is associated with a first interference measurement resource of the one or more interference measurement resources and a second interference measurement resource of the one or more interference measurement resources, a second hypothesis of the set of multiple hypotheses is associated with only the first interference measurement resource, and a third hypothesis of the set of multiple hypotheses is associated with only the second interference measurement resource.

In some examples, a first hypothesis of the set of multiple hypotheses is associated with a first interference measurement resource of the one or more interference measurement resources and a first power control backoff value, a second hypothesis of the set of multiple hypotheses is associated with the first interference measurement resource and a second power control backoff value, a third hypothesis of the set of multiple hypotheses is associated with a second interference measurement resource of the one or more interference measurement resources and the first power control backoff value, and a fourth hypothesis of the set of multiple hypotheses is associated with the second interference measurement resource and the second power control backoff value.

In some examples, a fifth hypothesis of the set of multiple hypotheses is associated with the first power control backoff value for the first interference measurement resource and the first power control backoff value for the second interference measurement resource, a sixth hypothesis of the set of multiple hypotheses is associated with the second power control backoff value for the first interference measurement resource and the second power control backoff value for the second interference measurement resource, a seventh hypothesis of the set of multiple hypotheses is associated with the first power control backoff value for the first interference measurement resource and the second power control backoff value for the second interference measurement resource, and an eighth hypothesis of the set of multiple hypotheses is associated with the second power control backoff value for the first interference measurement resource and the first power control backoff value for the second interference measurement resource.

In some examples, the one or more interference measurement resources include a set of multiple interference measurement resources for each network entity of a set of network entities, where the two or more hypotheses include hypotheses associated with any of N interference measurement resources of the set of multiple interference measurement resources for each network entity of the set of multiple network entities, where the N interference measurement resources are associated with a higher interference than each remaining interference measurement resource of the set of multiple interference measurement resources for each network entity of the set of multiple network entities, and where N is a positive integer.

In some examples, the one or more interference measurement resources include a set of multiple interference measurement resources for each network entity of a set of network entities, where the two or more hypotheses include hypotheses associated with any of N interference measurement resources of the set of multiple interference measurement resources for each network entity of the set of multiple network entities, where the N interference measurement resources are associated with a lower interference than each remaining interference measurement resource of the set of multiple interference measurement resources for each network entity of the set of multiple network entities, and where N is a positive integer.

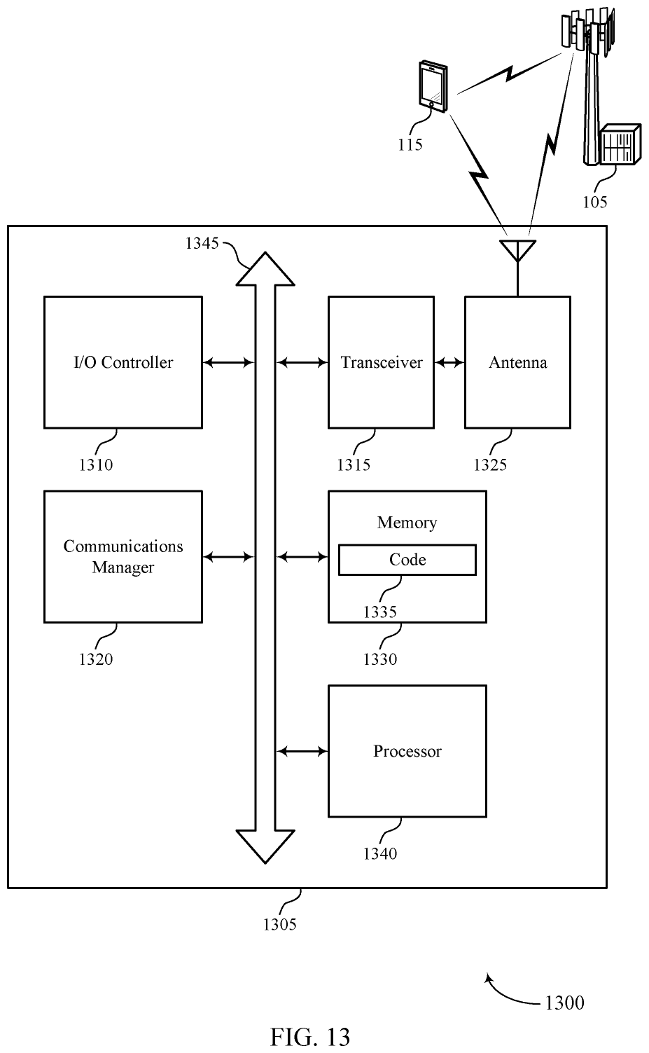

FIG. 13 shows a diagram of a system 1300 including a device 1305 that supports cross-link interference report with multiple hypotheses in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include random access memory (RAM) and read-only memory (ROM). The at least one memory 1330 may store computer-readable, computer-executable code 1335 including instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may contain, among other things, a basic I/O system (BIOS) which may control basic hardware or software operation such as the interaction with peripheral components or devices.

The at least one processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting cross-link interference report with multiple hypotheses). For example, the device 1305 or a component of the device 1305 may include at least one processor 1340 and at least one memory 1330 coupled with or to the at least one processor 1340, the at least one processor 1340 and at least one memory 1330 configured to perform various functions described herein. In some examples, the at least one processor 1340 may include multiple processors and the at least one memory 1330 may include multiple memories. One or more of the multiple processors may be coupled with one or more of the multiple memories, which may, individually or collectively, be configured to perform various functions herein. In some examples, the at least one processor 1340 may be a component of a processing system, which may refer to a system (such as a series) of machines, circuitry (including, for example, one or both of processor circuitry (which may include the at least one processor 1340) and memory circuitry (which may include the at least one memory 1330)), or components, that receives or obtains inputs and processes the inputs to produce, generate, or obtain a set of outputs. The processing system may be configured to perform one or more of the functions described herein. As such, the at least one processor 1340 or a processing system including the at least one processor 1340 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1330 or otherwise, to perform one or more of the functions described herein.

The communications manager 1320 may support wireless communication performed in accordance with examples as disclosed herein. For example, the communications manager 1320 is capable of, configured to, or operable to support a means for receiving, from a second network entity, first control information that includes first information and second information, where the first information is indicative of one or more interference measurement resources for measurement of cross-link interference (CLI) and the second information is indicative of a set of multiple hypotheses for one or more CLI determinations. The communications manager 1320 is capable of, configured to, or operable to support a means for transmitting, to the second network entity, a report that includes respective CLI information for each hypothesis of two or more of the set of multiple hypotheses, where the respective CLI information for each hypothesis of the two or more hypotheses is based on the first information indicative of the one or more interference measurement resources.

By including or configuring the communications manager 1320 in accordance with examples as described herein, the device 1305 may support techniques a device 1305 to reduce CLI via reporting of multiple hypotheses

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of cross-link interference report with multiple hypotheses as described herein, or the at least one processor 1340 and the at least one memory 1330 may be otherwise configured to, individually or collectively, perform or support such operations.

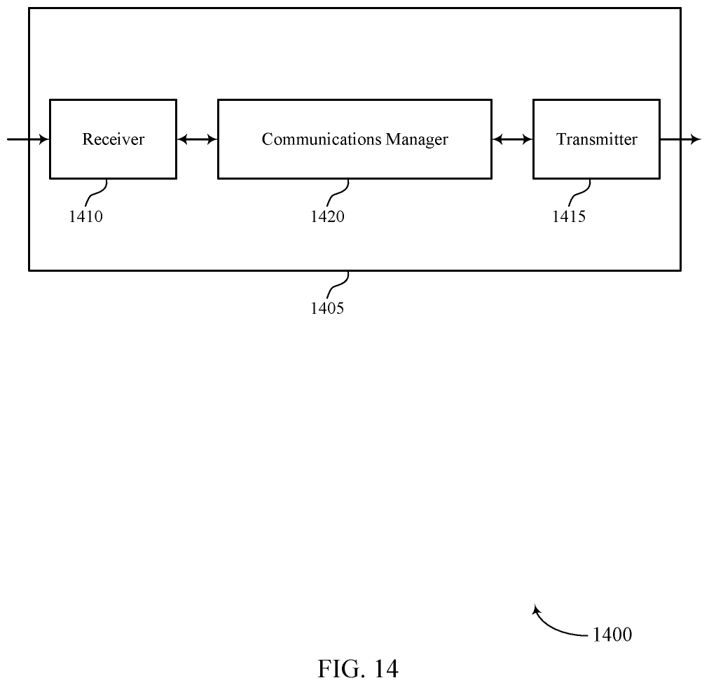

FIG. 14 shows a block diagram 1400 of a device 1405 that supports cross-link interference report with multiple hypotheses in accordance with one or more aspects of the present disclosure. The device 1405 may be an example of aspects of a network entity 105 as described herein. The device 1405 may include a receiver 1410, a transmitter 1415, and a communications manager 1420. The device 1405, or one or more components of the device 1405 (e.g., the receiver 1410, the transmitter 1415, and the communications manager 1420), may include at least one processor, which may be coupled with at least one memory, to, individually or collectively, support or enable the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations thereof or various components thereof may be examples of means for performing various aspects of cross-link interference report with multiple hypotheses as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1420, the receiver 1410, the transmitter 1415, or various combinations or components thereof may be implemented in code (e.g., as communications management software or firmware) executed by at least one processor. If implemented in code executed by at least one processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication performed in accordance with examples as disclosed herein. For example, the communications manager 1420 is capable of, configured to, or operable to support a means for transmitting, to a second network entity, first control information that includes first information and second information, where the first information is indicative of one or more interference measurement resources for measurement of cross-link interference (CLI) and the second information is indicative of a set of multiple hypotheses for one or more CLI determinations. The communications manager 1420 is capable of, configured to, or operable to support a means for receiving, from the second network entity, a report that includes respective CLI information for each hypothesis of two or more of the set of multiple hypotheses, where the respective CLI information for each hypothesis of the two or more hypotheses is based on the first information indicative of the one or more interference measurement resources.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for a device 1405 to reduce CLI via reporting of multiple hypotheses.

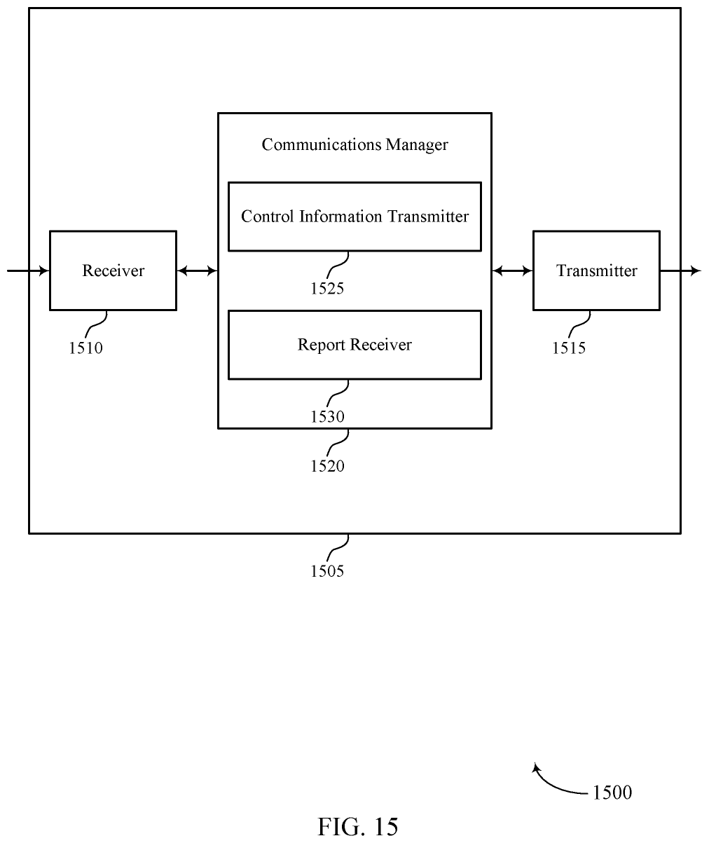

FIG. 15 shows a block diagram 1500 of a device 1505 that supports cross-link interference report with multiple hypotheses in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505, or one of more components of the device 1505 (e.g., the receiver 1510, the transmitter 1515, and the communications manager 1520), may include at least one processor, which may be coupled with at least one memory, to support the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of cross-link interference report with multiple hypotheses as described herein. For example, the communications manager 1520 may include a control information transmitter 1525 a report receiver 1530, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication performed in accordance with examples as disclosed herein. The control information transmitter 1525 is capable of, configured to, or operable to support a means for transmitting, to a second network entity, first control information that includes first information and second information, where the first information is indicative of one or more interference measurement resources for measurement of cross-link interference (CLI) and the second information is indicative of a set of multiple hypotheses for one or more CLI determinations. The report receiver 1530 is capable of, configured to, or operable to support a means for receiving, from the second network entity, a report that includes respective CLI information for each hypothesis of two or more of the set of multiple hypotheses, where the respective CLI information for each hypothesis of the two or more hypotheses is based on the first information indicative of the one or more interference measurement resources.

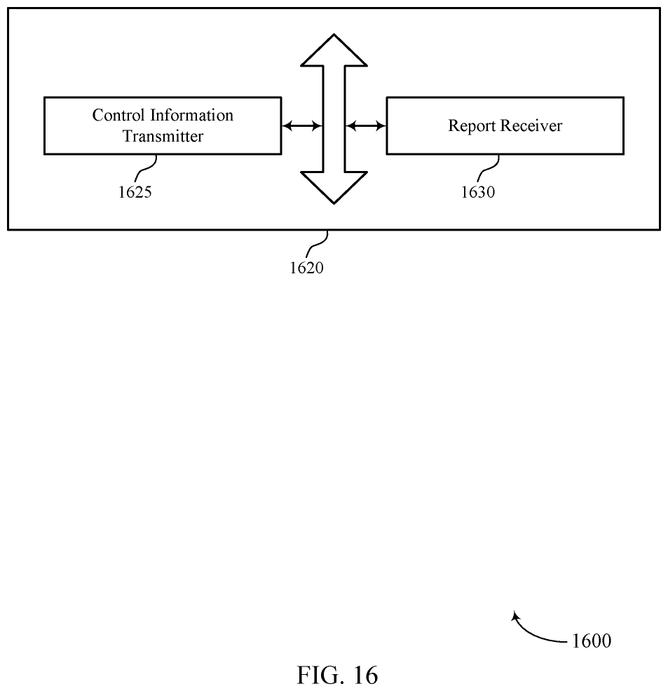

FIG. 16 shows a block diagram 1600 of a communications manager 1620 that supports cross-link interference report with multiple hypotheses in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of cross-link interference report with multiple hypotheses as described herein. For example, the communications manager 1620 may include a control information transmitter 1625 a report receiver 1630, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communication performed in accordance with examples as disclosed herein. The control information transmitter 1625 is capable of, configured to, or operable to support a means for transmitting, to a second network entity, first control information that includes first information and second information, where the first information is indicative of one or more interference measurement resources for measurement of cross-link interference (CLI) and the second information is indicative of a set of multiple hypotheses for one or more CLI determinations. The report receiver 1630 is capable of, configured to, or operable to support a means for receiving, from the second network entity, a report that includes respective CLI information for each hypothesis of two or more of the set of multiple hypotheses, where the respective CLI information for each hypothesis of the two or more hypotheses is based on the first information indicative of the one or more interference measurement resources.

In some examples, the two or more hypotheses include a first hypothesis and a second hypothesis. In some examples, the respective CLI information for the first hypothesis includes a channel quality indicator (CQI), a rank indicator (RI), a precoding matrix indicator (PMI), or a signal to interference plus noise ratio (SINR). In some examples, the first hypothesis is associated with an absence of CLI measurement and the second hypothesis that is associated with CLI measurement based on the one or more interference measurement resources.

In some examples, the two or more hypotheses include a first hypothesis associated with a first transmit power backoff value and a second hypothesis associated with a second transmit power backoff value. In some examples, each of the first transmit power backoff value and the second transmit power backoff value are equal to or greater than zero.

In some examples, the control information transmitter 1625 is capable of, configured to, or operable to support a means for transmitting, to the second network entity or a third network entity, second control information indicative of the first transmit power backoff value and the second transmit power backoff value.

In some examples, at least one interference measurement resource of the one or more interference measurement resources is associated with multiple hypotheses of the two or more hypotheses.

In some examples, a first interference measurement resource of the one or more interference measurement resources is associated with a first hypothesis of the two or more hypotheses and a second interference measurement resource of the one or more interference measurement resources is associated with a second hypothesis of the two or more hypotheses.

In some examples, a first hypothesis of the two or more hypotheses is based on a first interference measurement resource of the one or more interference measurement resources and a second interference measurement resource of the one or more interference measurement resources.

In some examples, a second hypothesis of the two or more hypotheses is based on only one of the first interference measurement resource or the second interference measurement resource.

In some examples, the first hypothesis is associated with a first transmit power backoff value and the second hypothesis is associated with a second transmit power backoff value.

In some examples, the two or more hypotheses include a first hypothesis associated with a first transmit beam of a third network entity and a second hypothesis associated with a second transmit beam of the third network entity.

In some examples, the two or more hypotheses include a first hypothesis associated with a first receive beam of the second network entity and a second hypothesis associated with a second receive beam of the second network entity.

In some examples, the two or more hypotheses include a first hypothesis associated with a third network entity and a second hypothesis associated with a fourth network entity.

In some examples, the two or more hypotheses has a first quantity of hypotheses and the set of multiple hypotheses has a second quantity of hypotheses. In some examples, the first quantity of hypotheses is less than the second quantity of hypotheses.

In some examples, the two or more hypotheses is based on a maximum quantity of hypotheses associated with the report.

In some examples, each hypothesis of the two or more hypotheses is associated with a larger amount of interference relative to each hypothesis of the set of multiple hypotheses that is excluded from the two or more hypotheses or each hypothesis of the two or more hypotheses is associated with a smaller amount of interference relative to each hypothesis of the set of multiple hypotheses that is excluded from the two or more hypotheses.

In some examples, the respective CLI information for each hypothesis of the two or more hypotheses includes a respective channel quality indicator (CQI), a respective rank indication (RI), a respective precoding matrix indicator (PMI), a respective received signal strength indicator (RSSI), a respective reference signal receive power (RSRP), or a respective signal to interference plus noise ratio (SINR).

In some examples, the first control information is indicated in a report configuration.

In some examples, each CLI determination of the one or more CLI determinations is associated with the respective CLI information or a respective measurement of CLI for a respective hypothesis of the two or more hypotheses.

In some examples, a first hypothesis of the set of multiple hypotheses is associated with a first interference measurement resource of the one or more interference measurement resources and a second interference measurement resource of the one or more interference measurement resources, a second hypothesis of the set of multiple hypotheses is associated with only the first interference measurement resource, and a third hypothesis of the set of multiple hypotheses is associated with only the second interference measurement resource.

In some examples, a first hypothesis of the set of multiple hypotheses is associated with a first interference measurement resource of the one or more interference measurement resources and a first power control backoff value, a second hypothesis of the set of multiple hypotheses is associated with the first interference measurement resource and a second power control backoff value, a third hypothesis of the set of multiple hypotheses is associated with a second interference measurement resource of the one or more interference measurement resources and the first power control backoff value, and a fourth hypothesis of the set of multiple hypotheses is associated with the second interference measurement resource and the second power control backoff value.

In some examples, a fifth hypothesis of the set of multiple hypotheses is associated with the first power control backoff value for the first interference measurement resource and the first power control backoff value for the second interference measurement resource, a sixth hypothesis of the set of multiple hypotheses is associated with the second power control backoff value for the first interference measurement resource and the second power control backoff value for the second interference measurement resource, a seventh hypothesis of the set of multiple hypotheses is associated with the first power control backoff value for the first interference measurement resource and the second power control backoff value for the second interference measurement resource, and an eighth hypothesis of the set of multiple hypotheses is associated with the second power control backoff value for the first interference measurement resource and the first power control backoff value for the second interference measurement resource.

In some examples, the one or more interference measurement resources include a set of multiple interference measurement resources for each network entity of a set of network entities, where the two or more hypotheses include hypotheses associated with any of N interference measurement resources of the set of multiple interference measurement resources for each network entity of the set of multiple network entities, where the N interference measurement resources are associated with a higher interference than each remaining interference measurement resource of the set of multiple interference measurement resources for each network entity of the set of multiple network entities, and where N is a positive integer.

In some examples, the one or more interference measurement resources include a set of multiple interference measurement resources for each network entity of a set of network entities, where the two or more hypotheses include hypotheses associated with any of N interference measurement resources of the set of multiple interference measurement resources for each network entity of the set of multiple network entities, where the N interference measurement resources are associated with a lower interference than each remaining interference measurement resource of the set of multiple interference measurement resources for each network entity of the set of multiple network entities, and where N is a positive integer.

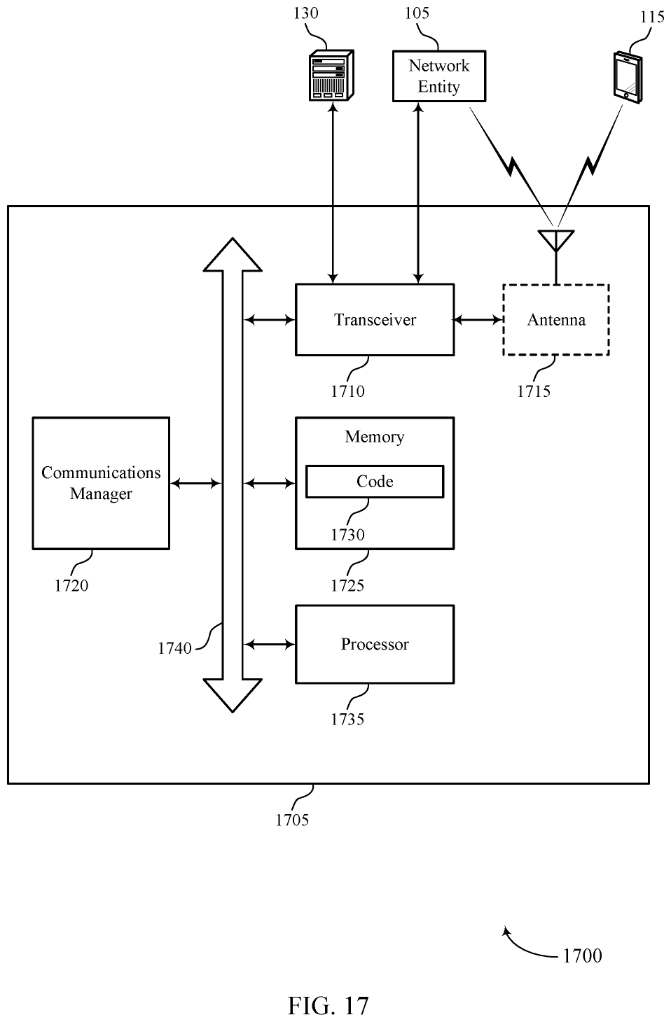

FIG. 17 shows a diagram of a system 1700 including a device 1705 that supports cross-link interference report with multiple hypotheses in accordance with one or more aspects of the present disclosure. The device 1705 may be an example of or include the components of a device 1405, a device 1505, or a network entity 105 as described herein. The device 1705 may communicate with one or more network entities 105, one or more UEs 115, or any combination thereof, which may include communications over one or more wired interfaces, over one or more wireless interfaces, or any combination thereof. The device 1705 may include components that support outputting and obtaining communications, such as a communications manager 1720, a transceiver 1710, an antenna 1715, at least one memory 1725, code 1730, and at least one processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or one or more memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or one or more memory components (e.g., the at least one processor 1735, the at least one memory 1725, or both), may be included in a chip or chip assembly that is installed in the device 1705. In some examples, the transceiver 1710 may be operable to support communications via one or more communications links (e.g., a communication link 125, a backhaul communication link 120, a midhaul communication link 162, a fronthaul communication link 168).

The at least one memory 1725 may include RAM, ROM, or any combination thereof. The at least one memory 1725 may store computer-readable, computer-executable code 1730 including instructions that, when executed by one or more of the at least one processor 1735, cause the device 1705 to perform various functions described herein. The code 1730 may be stored in a non-transitory computer-readable medium such as system memory or another type of memory. In some cases, the code 1730 may not be directly executable by a processor of the at least one processor 1735 but may cause a computer (e.g., when compiled and executed) to perform functions described herein. In some cases, the at least one memory 1725 may contain, among other things, a BIOS which may control basic hardware or software operation such as the interaction with peripheral components or devices. In some examples, the at least one processor 1735 may include multiple processors and the at least one memory 1725 may include multiple memories. One or more of the multiple processors may be coupled with one or more of the multiple memories which may, individually or collectively, be configured to perform various functions herein (for example, as part of a processing system).

The at least one processor 1735 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1735 may be configured to operate a memory array using a memory controller. In some other cases, a memory controller may be integrated into one or more of the at least one processor 1735. The at least one processor 1735 may be configured to execute computer-readable instructions stored in a memory (e.g., one or more of the at least one memory 1725) to cause the device 1705 to perform various functions (e.g., functions or tasks supporting cross-link interference report with multiple hypotheses). For example, the device 1705 or a component of the device 1705 may include at least one processor 1735 and at least one memory 1725 coupled with one or more of the at least one processor 1735, the at least one processor 1735 and the at least one memory 1725 configured to perform various functions described herein. The at least one processor 1735 may be an example of a cloud-computing platform (e.g., one or more physical nodes and supporting software such as operating systems, virtual machines, or container instances) that may host the functions (e.g., by executing code 1730) to perform the functions of the device 1705. The at least one processor 1735 may be any one or more suitable processors capable of executing scripts or instructions of one or more software programs stored in the device 1705 (such as within one or more of the at least one memory 1725). In some examples, the at least one processor 1735 may include multiple processors and the at least one memory 1725 may include multiple memories. One or more of the multiple processors may be coupled with one or more of the multiple memories, which may, individually or collectively, be configured to perform various functions herein. In some examples, the at least one processor 1735 may be a component of a processing system, which may refer to a system (such as a series) of machines, circuitry (including, for example, one or both of processor circuitry (which may include the at least one processor 1735) and memory circuitry (which may include the at least one memory 1725)), or components, that receives or obtains inputs and processes the inputs to produce, generate, or obtain a set of outputs. The processing system may be configured to perform one or more of the functions described herein. As such, the at least one processor 1735 or a processing system including the at least one processor 1735 may be configured to, configurable to, or operable to cause the device 1705 to perform one or more of the functions described herein. Further, as described herein, being “configured to,” being “configurable to,” and being “operable to” may be used interchangeably and may be associated with a capability, when executing code stored in the at least one memory 1725 or otherwise, to perform one or more of the functions described herein.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the at least one memory 1725, the code 1730, and the at least one processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with other network entities 105, and may include a controller or scheduler for controlling communications with UEs 115 in cooperation with other network entities 105. In some examples, the communications manager 1720 may support an X2 interface within an LTE/LTE-A wireless communications network technology to provide communication between network entities 105.

The communications manager 1720 may support wireless communication performed in accordance with examples as disclosed herein. For example, the communications manager 1720 is capable of, configured to, or operable to support a means for transmitting, to a second network entity, first control information that includes first information and second information, where the first information is indicative of one or more interference measurement resources for measurement of cross-link interference (CLI) and the second information is indicative of a set of multiple hypotheses for one or more CLI determinations. The communications manager 1720 is capable of, configured to, or operable to support a means for receiving, from the second network entity, a report that includes respective CLI information for each hypothesis of two or more of the set of multiple hypotheses, where the respective CLI information for each hypothesis of the two or more hypotheses is based on the first information indicative of the one or more interference measurement resources.

By including or configuring the communications manager 1720 in accordance with examples as described herein, the device 1705 may support techniques for a device 1705 to reduce CLI via reporting of multiple hypotheses

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, one or more of the at least one processor 1735, one or more of the at least one memory 1725, the code 1730, or any combination thereof (for example, by a processing system including at least a portion of the at least one processor 1735, the at least one memory 1725, the code 1730, or any combination thereof). For example, the code 1730 may include instructions executable by one or more of the at least one processor 1735 to cause the device 1705 to perform various aspects of cross-link interference report with multiple hypotheses as described herein, or the at least one processor 1735 and the at least one memory 1725 may be otherwise configured to, individually or collectively, perform or support such operations.

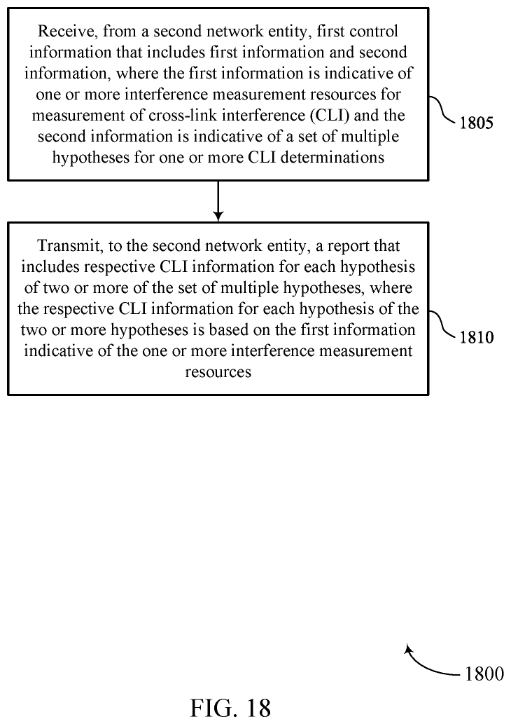

FIG. 18 shows a flowchart illustrating a method 1800 that supports cross-link interference report with multiple hypotheses in accordance with aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1805, the method may include receiving, from a second network entity, first control information that includes first information and second information, where the first information is indicative of one or more interference measurement resources for measurement of cross-link interference (CLI) and the second information is indicative of a set of multiple hypotheses for one or more CLI determinations. The operations of block 1805 may be performed in accordance with examples as disclosed herein. In some examples, aspects of the operations of 1805 may be performed by a control information receiver 1225 as described with reference to FIG. 12.

At 1810, the method may include transmitting, to the second network entity, a report that includes respective CLI information for each hypothesis of two or more of the set of multiple hypotheses, where the respective CLI information for each hypothesis of the two or more hypotheses is based on the first information indicative of the one or more interference measurement resources. The operations of block 1810 may be performed in accordance with examples as disclosed herein. In some examples, aspects of the operations of 1810 may be performed by a report transmitter 1230 as described with reference to FIG. 12.

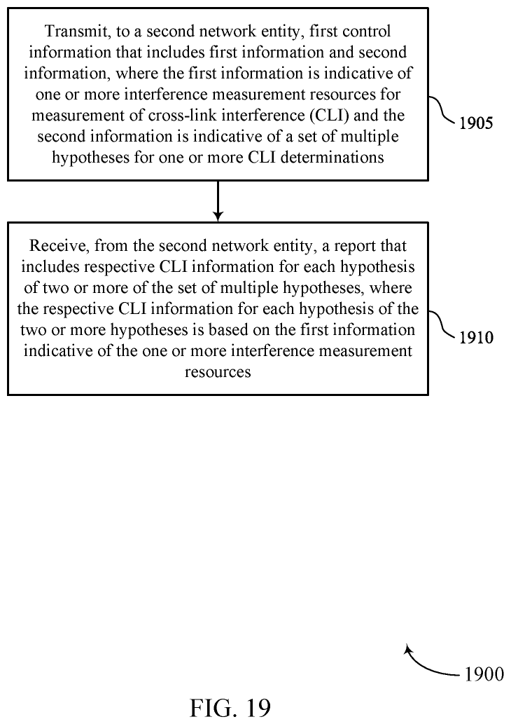

FIG. 19 shows a flowchart illustrating a method 1900 that supports cross-link interference report with multiple hypotheses in accordance with aspects of the present disclosure. The operations of the method 1900 may be implemented by a network entity or its components as described herein. For example, the operations of the method 1900 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a second network entity, first control information that includes first information and second information, where the first information is indicative of one or more interference measurement resources for measurement of cross-link interference (CLI) and the second information is indicative of a set of multiple hypotheses for one or more CLI determinations. The operations of block 1905 may be performed in accordance with examples as disclosed herein. In some examples, aspects of the operations of 1905 may be performed by a control information transmitter 1625 as described with reference to FIG. 16.

At 1910, the method may include receiving, from the second network entity, a report that includes respective CLI information for each hypothesis of two or more of the set of multiple hypotheses, where the respective CLI information for each hypothesis of the two or more hypotheses is based on the first information indicative of the one or more interference measurement resources. The operations of block 1910 may be performed in accordance with examples as disclosed herein. In some examples, aspects of the operations of 1910 may be performed by a report receiver 1630 as described with reference to FIG. 16.

The following provides an overview of aspects of the present disclosure:
Aspect 1: A method for wireless communication performed by a first network entity, comprising: receiving, from a second network entity, first control information that includes first information and second information, wherein the first information is indicative of one or more interference measurement resources for measurement of CLI and the second information is indicative of a plurality of hypotheses for one or more CLI determinations; and transmitting, to the second network entity, a report that includes respective CLI information for each hypothesis of two or more of the plurality of hypotheses, wherein the respective CLI information for each hypothesis of the two or more hypotheses is based on the first information indicative of the one or more interference measurement resources.
Aspect 2: The method of aspect 1, wherein the two or more hypotheses include a first hypothesis and a second hypothesis, the respective CLI information for the first hypothesis includes a CQI, a RI, a PMI, or a SINR, the first hypothesis is associated with an absence of CLI measurement and the second hypothesis that is associated with CLI measurement based on the one or more interference measurement resources.
Aspect 3: The method of any of aspects 1 through 2, wherein the two or more hypotheses include a first hypothesis associated with a first transmit power backoff value and a second hypothesis associated with a second transmit power backoff value, each of the first transmit power backoff value and the second transmit power backoff value are equal to or greater than zero.
Aspect 4: The method of aspect 3, further comprising: receiving, from the second network entity, second control information indicative of the first transmit power backoff value and the second transmit power backoff value.
Aspect 5: The method of any of aspects 1 through 4, wherein at least one interference measurement resource of the one or more interference measurement resources is associated with multiple hypotheses of the two or more hypotheses.
Aspect 6: The method of any of aspects 1 through 5, wherein a first interference measurement resource of the one or more interference measurement resources is associated with a first hypothesis of the two or more hypotheses and a second interference measurement resource of the one or more interference measurement resources is associated with a second hypothesis of the two or more hypotheses.
Aspect 7: The method of any of aspects 1 through 6, wherein a first hypothesis of the plurality of hypotheses is associated with a first interference measurement resource of the one or more interference measurement resources and a second interference measurement resource of the one or more interference measurement resources, a second hypothesis of the plurality of hypotheses is associated with only the first interference measurement resource, and a third hypothesis of the plurality of hypotheses is associated with only the second interference measurement resource.
Aspect 8: The method of any of aspects 1 through 7, wherein a first hypothesis of the plurality of hypotheses is associated with a first interference measurement resource of the one or more interference measurement resources and a first power control backoff value, a second hypothesis of the plurality of hypotheses is associated with the first interference measurement resource and a second power control backoff value, a third hypothesis of the plurality of hypotheses is associated with a second interference measurement resource of the one or more interference measurement resources and the first power control backoff value, and a fourth hypothesis of the plurality of hypotheses is associated with the second interference measurement resource and the second power control backoff value.
Aspect 9: The method of aspect 8, wherein a fifth hypothesis of the plurality of hypotheses is associated with the first power control backoff value for the first interference measurement resource and the first power control backoff value for the second interference measurement resource, a sixth hypothesis of the plurality of hypotheses is associated with the second power control backoff value for the first interference measurement resource and the second power control backoff value for the second interference measurement resource, a seventh hypothesis of the plurality of hypotheses is associated with the first power control backoff value for the first interference measurement resource and the second power control backoff value for the second interference measurement resource, and an eighth hypothesis of the plurality of hypotheses is associated with the second power control backoff value for the first interference measurement resource and the first power control backoff value for the second interference measurement resource.
Aspect 10: The method of any of aspects 1 through 9, wherein the two or more hypotheses include a first hypothesis associated with a first transmit beam of a third network entity and a second hypothesis associated with a second transmit beam of the third network entity.
Aspect 11: The method of any of aspects 1 through 10, wherein the two or more hypotheses include a first hypothesis associated with a CLI measurement associated with a first receive beam of the first network entity and a second hypothesis associated with a second receive beam of the first network entity.
Aspect 12: The method of any of aspects 1 through 11, wherein the two or more hypotheses include a first hypothesis associated with a third network entity and a second hypothesis associated with a fourth network entity.
Aspect 13: The method of any of aspects 1 through 12, wherein the two or more hypotheses has a first quantity of hypotheses and the plurality of hypotheses has a second quantity of hypotheses, the first quantity of hypotheses is less than the second quantity of hypotheses.
Aspect 14: The method of aspect 13, further comprising: determining the two or more hypotheses based on a maximum quantity of hypotheses associated with the report.
Aspect 15: The method of aspect 14, wherein determining the two or more hypotheses based on maximum quantity of hypotheses associated with the report comprises: selecting the two or more hypotheses.
Aspect 16: The method of aspect 15, further comprising: generating, based on selecting the two or more hypotheses, the report to include the respective CLI information for each hypothesis of the two or more hypotheses.
Aspect 17: The method of any of aspects 1 through 16, wherein the one or more interference measurement resources comprise a plurality of interference measurement resources for each network entity of a set of network entities, the two or more hypotheses comprise hypotheses associated with any of N interference measurement resources of the plurality of interference measurement resources for each network entity of the plurality of network entities, the N interference measurement resources are associated with a higher interference than each remaining interference measurement resource of the plurality of interference measurement resources for each network entity of the plurality of network entities, and N is a positive integer.
Aspect 18: The method of any of aspects 1 through 17, wherein the one or more interference measurement resources comprise a plurality of interference measurement resources for each network entity of a set of network entities, the two or more hypotheses comprise hypotheses associated with any of N interference measurement resources of the plurality of interference measurement resources for each network entity of the plurality of network entities, the N interference measurement resources are associated with a lower interference than each remaining interference measurement resource of the plurality of interference measurement resources for each network entity of the plurality of network entities, and N is a positive integer.
Aspect 19: The method of any of aspects 1 through 18, wherein the respective CLI information for each hypothesis of the two or more hypotheses includes a respective CQI, a respective RI, a respective PMI, a respective RSSI, a respective RSRP, or a respective SINR.
Aspect 20: The method of any of aspects 1 through 19, wherein the report includes channel state information.
Aspect 21: The method of any of aspects 1 through 20, wherein the first control information is indicated in a report configuration.
Aspect 22: The method of any of aspects 1 through 21, wherein each CLI determination of the one or more CLI determinations is associated with the respective CLI information or a respective measurement of CLI for a respective hypothesis of the two or more hypotheses.
Aspect 23: The method of any of aspects 1 through 22, further comprising: generating, based on the one or more interference measurement resources, the respective CLI information for each hypothesis of the two or more hypotheses.
Aspect 24: The method of aspect 23, wherein generating, based on the one or more interference measurement resources, the respective CLI information for each hypothesis of the one or more hypotheses comprises: measuring the one or more interference measurement resources.
Aspect 25: A method for wireless communication performed by a first network entity, comprising: transmitting, to a second network entity, first control information that includes first information and second information, wherein the first information is indicative of one or more interference measurement resources for measurement of CLI and the second information is indicative of a plurality of hypotheses for one or more CLI determinations; and receiving, from the second network entity, a report that includes respective CLI information for each hypothesis of two or more of the plurality of hypotheses, wherein the respective CLI information for each hypothesis of the two or more hypotheses is based on the first information indicative of the one or more interference measurement resources.
Aspect 26: The method of aspect 25, wherein the two or more hypotheses include a first hypothesis and a second hypothesis, the respective CLI information for the first hypothesis includes a CQI, a RI, a PMI, or a SINR, the first hypothesis is associated with an absence of CLI measurement and the second hypothesis that is associated with CLI measurement based on the one or more interference measurement resources.
Aspect 27: The method of any of aspects 25 through 26, wherein the two or more hypotheses include a first hypothesis associated with a first transmit power backoff value and a second hypothesis associated with a second transmit power backoff value, each of the first transmit power backoff value and the second transmit power backoff value are equal to or greater than zero.
Aspect 28: The method of aspect 27, further comprising: transmitting, to the second network entity or a third network entity, second control information indicative of the first transmit power backoff value and the second transmit power backoff value.
Aspect 29: The method of any of aspects 25 through 28, wherein at least one interference measurement resource of the one or more interference measurement resources is associated with multiple hypotheses of the two or more hypotheses.
Aspect 30: The method of any of aspects 25 through 29, wherein a first interference measurement resource of the one or more interference measurement resources is associated with a first hypothesis of the two or more hypotheses and a second interference measurement resource of the one or more interference measurement resources is associated with a second hypothesis of the two or more hypotheses.
Aspect 31: The method of any of aspects 25 through 30, wherein a first hypothesis of the plurality of hypotheses is associated with a first interference measurement resource of the one or more interference measurement resources and a second interference measurement resource of the one or more interference measurement resources, a second hypothesis of the plurality of hypotheses is associated with only the first interference measurement resource, and a third hypothesis of the plurality of hypotheses is associated with only the second interference measurement resource.
Aspect 32: The method of any of aspects 25 through 31, wherein a first hypothesis of the plurality of hypotheses is associated with a first interference measurement resource of the one or more interference measurement resources and a first power control backoff value, a second hypothesis of the plurality of hypotheses is associated with the first interference measurement resource and a second power control backoff value, a third hypothesis of the plurality of hypotheses is associated with a second interference measurement resource of the one or more interference measurement resources and the first power control backoff value, and a fourth hypothesis of the plurality of hypotheses is associated with the second interference measurement resource and the second power control backoff value.
Aspect 33: The method of aspect 32, wherein a fifth hypothesis of the plurality of hypotheses is associated with the first power control backoff value for the first interference measurement resource and the first power control backoff value for the second interference measurement resource, a sixth hypothesis of the plurality of hypotheses is associated with the second power control backoff value for the first interference measurement resource and the second power control backoff value for the second interference measurement resource, a seventh hypothesis of the plurality of hypotheses is associated with the first power control backoff value for the first interference measurement resource and the second power control backoff value for the second interference measurement resource, and an eighth hypothesis of the plurality of hypotheses is associated with the second power control backoff value for the first interference measurement resource and the first power control backoff value for the second interference measurement resource.
Aspect 34: The method of any of aspects 25 through 33, wherein the two or more hypotheses include a first hypothesis associated with a first transmit beam of a third network entity and a second hypothesis associated with a second transmit beam of the third network entity.
Aspect 35: The method of any of aspects 25 through 34, wherein the two or more hypotheses include a first hypothesis associated with a first receive beam of the second network entity and a second hypothesis associated with a second receive beam of the second network entity.
Aspect 36: The method of any of aspects 25 through 35, wherein the two or more hypotheses include a first hypothesis associated with a third network entity and a second hypothesis associated with a fourth network entity.
Aspect 37: The method of any of aspects 25 through 36, wherein the two or more hypotheses has a first quantity of hypotheses and the plurality of hypotheses has a second quantity of hypotheses, the first quantity of hypotheses is less than the second quantity of hypotheses.
Aspect 38: The method of aspect 37, wherein the two or more hypotheses is based on a maximum quantity of hypotheses associated with the report.
Aspect 39: The method of any of aspects 25 through 38, wherein the one or more interference measurement resources comprise a plurality of interference measurement resources for each network entity of a plurality of network entities, the two or more hypotheses comprise hypotheses associated with any of N interference measurement resources of the plurality of interference measurement resources for each network entity of the plurality of network entities, the N interference measurement resources are associated with a higher interference than each remaining interference measurement resource of the plurality of interference measurement resources for each network entity of the plurality of network entities, and N is a positive integer.
Aspect 40: The method of any of aspects 25 through 39, wherein the one or more interference measurement resources comprise a plurality of interference measurement resources for each network entity of a plurality of network entities, the two or more hypotheses comprise hypotheses associated with any of N interference measurement resources of the plurality of interference measurement resources for each network entity of the plurality of network entities, the N interference measurement resources are associated with a lower interference than each remaining interference measurement resource of the plurality of interference measurement resources for each network entity of the plurality of network entities, and N is a positive integer.
Aspect 41: The method of any of aspects 25 through 40, wherein the respective CLI information for each hypothesis of the two or more hypotheses includes a respective CQI, a respective RI, a respective PMI, a respective RSSI, a respective RSRP, or a respective SINR.
Aspect 42: The method of any of aspects 25 through 41, wherein the first control information is indicated in a report configuration.
Aspect 43: The method of any of aspects 25 through 42, wherein each CLI determination of the one or more CLI determinations is associated with the respective CLI information or a respective measurement of CLI for a respective hypothesis of the two or more hypotheses.
Aspect 44: A first network entity for wireless communication, comprising at least one communication interface and at least one processor coupled to the at least one communication interface, wherein the first network entity is configured to perform a method of any of aspects 1 through 24.
Aspect 45: A first network entity for wireless communication, comprising at least one means for performing a method of any of aspects 1 through 24.
Aspect 46: A non-transitory computer-readable medium storing code for wireless communication, the code comprising instructions executable by a processor to perform a method of any of aspects 1 through 24.
Aspect 47: A first network entity for wireless communication, comprising at least one communication interface and at least one processor coupled to the at least one communication interface, wherein the first network entity is configured to perform a method of any of aspects 25 through 43.
Aspect 48: A first network entity for wireless communication, comprising at least one means for performing a method of any of aspects 25 through 43.
Aspect 49: A non-transitory computer-readable medium storing code for wireless communication, the code comprising instructions executable by a processor to perform a method of any of aspects 25 through 43.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

N

What is claimed is:

1. A first network entity for wireless communication, comprising:
at least one communication interface; and
at least one processor coupled to the at least one communication interface, wherein the first network entity is configured to:
receive, from a second network entity, first control information that includes first information and second information, wherein the first information is indicative of one or more interference measurement resources for measurement of cross-link interference (CLI) and the second information is indicative of a plurality of hypotheses for one or more CLI determinations; and
transmit, to the second network entity, a report that includes respective CLI information for each hypothesis of two or more of the plurality of hypotheses, wherein the respective CLI information for each hypothesis of the two or more hypotheses is based on the first information indicative of the one or more interference measurement resources.

2. The first network entity of claim 1, wherein:
the two or more hypotheses include a first hypothesis and a second hypothesis,
the respective CLI information for the first hypothesis includes a channel quality indicator (CQI), a rank indicator (RI), a precoding matrix indicator (PMI), or a signal to interference plus noise ratio (SINR), and
the first hypothesis is associated with an absence of CLI measurement and the second hypothesis that is associated with CLI measurement based on the one or more interference measurement resources.

3. The first network entity of claim 1, wherein:
the two or more hypotheses include a first hypothesis associated with a first transmit power backoff value and a second hypothesis associated with a second transmit power backoff value, and
each of the first transmit power backoff value and the second transmit power backoff value are equal to or greater than zero.

4. The first network entity of claim 3, wherein the first network entity is further configured to:
receive, from the second network entity, second control information indicative of the first transmit power backoff value and the second transmit power backoff value.

5. The first network entity of claim 1, wherein at least one interference measurement resource of the one or more interference measurement resources is associated with multiple hypotheses of the two or more hypotheses.

6. The first network entity of claim 1, wherein a first interference measurement resource of the one or more interference measurement resources is associated with a first hypothesis of the two or more hypotheses and a second interference measurement resource of the one or more interference measurement resources is associated with a second hypothesis of the two or more hypotheses.

7. The first network entity of claim 1, wherein a first hypothesis of the plurality of hypotheses is associated with a first interference measurement resource of the one or more interference measurement resources and a second interference measurement resource of the one or more interference measurement resources,
a second hypothesis of the plurality of hypotheses is associated with only the first interference measurement resource, and
a third hypothesis of the plurality of hypotheses is associated with only the second interference measurement resource.

8. The first network entity of claim 1, wherein a first hypothesis of the plurality of hypotheses is associated with a first interference measurement resource of the one or more interference measurement resources and a first power control backoff value,
a second hypothesis of the plurality of hypotheses is associated with the first interference measurement resource and a second power control backoff value,
a third hypothesis of the plurality of hypotheses is associated with a second interference measurement resource of the one or more interference measurement resources and the first power control backoff value,
a fourth hypothesis of the plurality of hypotheses is associated with the second interference measurement resource and the second power control backoff value,
a fifth hypothesis of the plurality of hypotheses is associated with the first power control backoff value for the first interference measurement resource and the first power control backoff value for the second interference measurement resource,
a sixth hypothesis of the plurality of hypotheses is associated with the second power control backoff value for the first interference measurement resource and the second power control backoff value for the second interference measurement resource,
a seventh hypothesis of the plurality of hypotheses is associated with the first power control backoff value for the first interference measurement resource and the second power control backoff value for the second interference measurement resource, and
an eighth hypothesis of the plurality of hypotheses is associated with the second power control backoff value for the first interference measurement resource and the first power control backoff value for the second interference measurement resource.

9. The first network entity of claim 1, wherein the two or more hypotheses include a first hypothesis associated with a first transmit beam of a third network entity and a second hypothesis associated with a second transmit beam of the third network entity.

10. The first network entity of claim 1, wherein the two or more hypotheses include a first hypothesis associated with a first receive beam of the first network entity and a second hypothesis associated with a second receive beam of the first network entity.

11. The first network entity of claim 1, wherein the two or more hypotheses include a first hypothesis associated with a third network entity and a second hypothesis associated with a fourth network entity.

12. The first network entity of claim 1, wherein the one or more interference measurement resources comprise a plurality of interference measurement resources for each network entity of a plurality of network entities,
wherein the two or more hypotheses comprise hypotheses associated with any of N interference measurement resources of the plurality of interference measurement resources for each network entity of the plurality of network entities,
wherein the N interference measurement resources are associated with a higher interference than each remaining interference measurement resource of the plurality of interference measurement resources for each network entity of the plurality of network entities, and
wherein N is a positive integer.

13. The first network entity of claim 1, wherein the one or more interference measurement resources comprise a plurality of interference measurement resources for each network entity of a plurality of network entities,
wherein the two or more hypotheses comprise hypotheses associated with any of N interference measurement resources of the plurality of interference measurement resources for each network entity of the plurality of network entities,
wherein the N interference measurement resources are associated with a lower interference than each remaining interference measurement resource of the plurality of interference measurement resources for each network entity of the plurality of network entities, and
wherein N is a positive integer.

14. The first network entity of claim 1, wherein the respective CLI information for each hypothesis of the two or more hypotheses includes a respective channel quality indicator (CQI), a respective rank indicator (RI), a respective precoding matrix indicator (PMI), a respective received signal strength indicator (RSSI), a respective reference signal receive power (RSRP), or a respective signal to interference plus noise ratio (SINR).

15. The first network entity of claim 1, wherein the report includes channel state information.

16. The first network entity of claim 1, wherein each CLI determination of the one or more CLI determinations is associated with the respective CLI information or a respective measurement of CLI for a respective hypothesis of the two or more hypotheses.

17. The first network entity of claim 1, wherein the first network entity is further configured to:
generate, based on the one or more interference measurement resources, the respective CLI information for each hypothesis of the two or more hypotheses.

18. The first network entity of claim 17, wherein to generate, based on the one or more interference measurement resources, the respective CLI information for each hypothesis of the two or more hypotheses, the first network entity is configured to measure the one or more interference measurement resources.

19. A first network entity for wireless communication, comprising:
at least one communication interface; and
at least one processor coupled to the at least one communication interface, wherein the first network entity is configured to:
transmit, to a second network entity, first control information that includes first information and second information, wherein the first information is indicative of one or more interference measurement resources for measurement of cross-link interference (CLI) and the second information is indicative of a plurality of hypotheses for one or more CLI determinations; and
receive, from the second network entity, a report that includes respective CLI information for each hypothesis of two or more of the plurality of hypotheses, wherein the respective CLI information for each hypothesis of the two or more hypotheses is based on the first information indicative of the one or more interference measurement resources.

20. The first network entity of claim 19, wherein:
the two or more hypotheses include a first hypothesis and a second hypothesis,
the respective CLI information for the first hypothesis includes a channel quality indicator (CQI), a rank indicator (RI), a precoding matrix indicator (PMI), or a signal to interference plus noise ratio (SINR), and
the first hypothesis is associated with an absence of CLI measurement and the second hypothesis that is associated with CLI measurement based on the one or more interference measurement resources.

21. The first network entity of claim 19, wherein:
the two or more hypotheses include a first hypothesis associated with a first transmit power backoff value and a second hypothesis associated with a second transmit power backoff value, and
each of the first transmit power backoff value and the second transmit power backoff value are equal to or greater than zero.

22. The first network entity of claim 21, wherein the first network entity is further configured to:
transmit, to the second network entity or a third network entity, second control information indicative of the first transmit power backoff value and the second transmit power backoff value.

23. The first network entity of claim 19, wherein at least one interference measurement resource of the one or more interference measurement resources is associated with multiple hypotheses of the two or more hypotheses.

24. The first network entity of claim 19, wherein a first interference measurement resource of the one or more interference measurement resources is associated with a first hypothesis of the two or more hypotheses and a second interference measurement resource of the one or more interference measurement resources is associated with a second hypothesis of the two or more hypotheses.

25. The first network entity of claim 19, wherein a first hypothesis of the plurality of hypotheses is associated with a first interference measurement resource of the one or more interference measurement resources and a second interference measurement resource of the one or more interference measurement resources,
a second hypothesis of the plurality of hypotheses is associated with only the first interference measurement resource, and
a third hypothesis of the plurality of hypotheses is associated with only the second interference measurement resource.

26. The first network entity of claim 19, wherein a first hypothesis of the plurality of hypotheses is associated with a first interference measurement resource of the one or more interference measurement resources and a first power control backoff value,
a second hypothesis of the plurality of hypotheses is associated with the first interference measurement resource and a second power control backoff value,
a third hypothesis of the plurality of hypotheses is associated with a second interference measurement resource of the one or more interference measurement resources and the first power control backoff value, and
a fourth hypothesis of the plurality of hypotheses is associated with the second interference measurement resource and the second power control backoff value,
a fifth hypothesis of the plurality of hypotheses is associated with the first power control backoff value for the first interference measurement resource and the first power control backoff value for the second interference measurement resource,
a sixth hypothesis of the plurality of hypotheses is associated with the second power control backoff value for the first interference measurement resource and the second power control backoff value for the second interference measurement resource,
a seventh hypothesis of the plurality of hypotheses is associated with the first power control backoff value for the first interference measurement resource and the second power control backoff value for the second interference measurement resource, and
an eighth hypothesis of the plurality of hypotheses is associated with the second power control backoff value for the first interference measurement resource and the first power control backoff value for the second interference measurement resource.

27. The first network entity of claim 19, wherein the two or more hypotheses include a first hypothesis associated with a first transmit beam of a third network entity and a second hypothesis associated with a second transmit beam of the third network entity.

28. The first network entity of claim 19, wherein the two or more hypotheses include a first hypothesis associated with a first receive beam of the second network entity and a second hypothesis associated with a second receive beam of the second network entity.

29. The first network entity of claim 19, wherein the two or more hypotheses include a first hypothesis associated with a third network entity and a second hypothesis associated with a fourth network entity.

30. The first network entity of claim 19, wherein the one or more interference measurement resources comprise a plurality of interference measurement resources for each network entity of a plurality of network entities,
wherein the two or more hypotheses comprise hypotheses associated with any of N interference measurement resources of the plurality of interference measurement resources for each network entity of the plurality of network entities,
wherein the N interference measurement resources are associated with a higher interference than each remaining interference measurement resource of the plurality of interference measurement resources for each network entity of the plurality of network entities, and
wherein N is a positive integer.

31. The first network entity of claim 19, wherein the one or more interference measurement resources comprise a plurality of interference measurement resources for each network entity of a plurality of network entities,
wherein the two or more hypotheses comprise hypotheses associated with any of N interference measurement resources of the plurality of interference measurement resources for each network entity of the plurality of network entities,
wherein the N interference measurement resources are associated with a lower interference than each remaining interference measurement resource of the plurality of interference measurement resources for each network entity of the plurality of network entities, and
wherein N is a positive integer.

32. The first network entity of claim 19, wherein the respective CLI information for each hypothesis of the two or more hypotheses includes a respective channel quality indicator (CQI), a respective rank indication (RI), a respective precoding matrix indicator (PMI), a respective received signal strength indicator (RSSI), a respective reference signal receive power (RSRP), or a respective signal to interference plus noise ratio (SINR).

33. The first network entity of claim 19, wherein each CLI determination of the one or more CLI determinations is associated with the respective CLI information or a respective measurement of CLI for a respective hypothesis of the two or more hypotheses.

34. A method for wireless communication performed by a first network entity, comprising:
receiving, from a second network entity, first control information that includes first information and second information, wherein the first information is indicative of one or more interference measurement resources for measurement of cross-link interference (CLI) and the second information is indicative of a plurality of hypotheses for one or more CLI determinations; and
transmitting, to the second network entity, a report that includes respective CLI information for each hypothesis of two or more of the plurality of hypotheses, wherein the respective CLI information for each hypothesis of the two or more hypotheses is based on the first information indicative of the one or more interference measurement resources.

35. A method for wireless communication performed by a first network entity, comprising:
transmitting, to a second network entity, first control information that includes first information and second information, wherein the first information is indicative of one or more interference measurement resources for measurement of cross-link interference (CLI) and the second information is indicative of a plurality of hypotheses for one or more CLI determinations; and
receiving, from the second network entity, a report that includes respective CLI information for each hypothesis of two or more of the plurality of hypotheses, wherein the respective CLI information for each hypothesis of the two or more hypotheses is based on the first information indicative of the one or more interference measurement resources.
